(19) United States
(12) Patent Application Publication
(10) Pub. No.: US 2012/0185177 A1
(43) Pub. Date: Jul. 19, 2012

(54) HARNESSING HIGH THROUGHPUT SEQUENCING FOR MULTIPLEXED SPECIMEN ANALYSIS

(76) Inventors: Gregory J. Hannon, Huntington, NY (US); Yaniv Erlich, Cold Spring Harbor, NY (US)

(21) Appl. No.: 13/201,399

(22) PCT Filed: Feb. 19, 2010
(86) PCT No.: PCT/US10/24795

§ 371 Date: Mar. 22, 2012

Related U.S. Application Data
(60) Provisional application No. 61/154,293, filed on Feb. 20, 2009.
(60) Provisional application No. 61/174,532, filed on May 1, 2009.
(60) Provisional application No. 61/227,233, filed on Jul. 21, 2009.

(51) Int. Cl. G06F 19/00; C40B 20/00

(52) U.S. Cl. 702/20; 506/2

(57) ABSTRACT

A method of associating a DNA sequence with a specimen pooled among a plurality of specimens, where the specimens may be pooled according to any number of pooling schemes, including the Chinese Remainder Theorem, random pool selection, shifted transversal design, and Chinese Remainder Sieve. A unique identifier is associated with each specimen according to the pooling scheme such that a decoder may associate a DNA sequence with each specimen after next-generation sequencing according to the unique identifier and the chosen pooling scheme.

This application claims the benefit of the filing date of U.S. Provisional Patent Application No. 61/154,293, filed Feb. 20, 2009, U.S. Provisional Patent Application No. 61/174,532, filed May 1, 2009, and U.S. Provisional Patent Application No. 61/227,233, filed Jul. 21, 2009, the contents of which are hereby incorporated by reference.

This invention was made, in part, with government support under Grant Nos. 5P01 CA013106-39 and 2R01 GM062534-10 awarded by the National Institutes of Health. The United States government has certain rights in this invention.

This patent disclosure contains material which is subject to copyright protection. The copyright owner has no objection to the facsimile reproduction by anyone of the patent document or the patent disclosure, as it appears in the U.S. Patent and Trademark Office patent file or records, but otherwise reserves any and all copyright rights.

Throughout this application, patent applications, published patent applications, issued and granted patents, texts, and literature references are cited. For the purposes of the United States and other jurisdictions that allow incorporation by reference, the disclosures of these publications are incorporated by reference into this application.

### BACKGROUND OF THE INVENTION

Recently, a new class of DNA sequencer methods, dubbed next-generation sequencing technologies (NGST) has emerged, revolutionizing molecular biology and genomics. Next-generation sequencers have sufficient power to simultaneously analyze DNA from many different specimens, a practice known as multiplexing. Such schemes rely on the ability to associate each sequence read with the specimen from which it was derived.

Next-generation sequencers process the DNA fragments in parallel and provide millions of sequence reads in a single batch, each of which corresponds to a DNA molecule within the sample. While there are several types of NGST platforms and different sets of sequencing reactions, all platforms achieve parallelization using a common concept of immobilizing the DNA fragments to a surface, so that each fragment occupies a distinct spatial position. When the sequencing fragments are applied to the surface, they generate optical signals dependent on the DNA sequence, which are then captured by a microscope and processed. For example, referring to FIG. 1A, since the fragments are immobilized, successive signals from the same spatial location convey the DNA sequence of the corresponding fragment. However, the spatial locations of the DNA fragments are completely random and are based on stochastic hybridization of a small aliquot (millions) of DNA fragments out of significantly larger number present in a sample. Therefore, if a DNA library is composed of multiple specimens, it is not possible to associate the sequence reads with their corresponding specimens. This limitation is the main obstacle to the utilization of next generation sequencers in large scale screens, since dedicating a run to each specimen is not cost effective.

A simple solution to overcome the specimen-multiplexing problem is to append unique identifiers, dubbed DNA barcodes, to each specimen prior to sequencing. These barcodes are short DNA molecules that are artificially synthesized, and when attached to the DNA fragment, they label it with a unique sequence. The sequencer reads the entire fragment, and reports the sequence of the barcode with the sequence of the interrogated region. By reading the portion of the sequence corresponding to the barcode, the experimenter can associate a genotyped fragment with a given specimen (FIG. 1B). While this method was found quite successful for genotyping several dozens of specimens, the synthesis and ligation of large number of DNA fragments is both cumbersome and expensive. This restricts the scalability of the method for genetic screens that consist of thousands of individuals.

There are many biological applications wherein the sequence of a small region of DNA is determined from many independent specimens and wherein the link between the specimen and the sequence is preserved. Examples include studies of variation within specific regions from a large population, looking for correlations between variants and phenotype in areas that might have been narrowed by prior linkage analysis, or even medical diagnostics. For instance, a carrier screen is a genetic test for detecting individuals that are heterozygous for a risk allele of a severe genetic disease. If two carriers breed, they have 25% chance of having an affected offspring for each carriage. In some countries that face high prevalence of severe genetic diseases the practice is to offer a screen to the entire population, regardless their familial history for early monitoring and prevention.

Many problems are presented by trying to reduce the cost of multiplexing, and the inventors of the present invention propose a move from capillary sequencing platforms to NGST. Many simple pooling patterns are possible, however, many are insufficiently robust and uncertainties in linking clones to their source wells mount quickly as the numbers of specimens increase. For example, as shown in FIG. 2, one simple approach views a specimen collection as a simple matrix of rows and columns. Pooling all the specimens in each row and pooling all clones in each column yields pools equivalent to 2\sqrt{N}, where N is the number of clones (if the array is symmetrical). A specific sequence will appear coupled to a particular row identifier and also with a particular column identifier.

While this may indicate a unique position in the specimen array, the approach breaks down immediately if not every sequence in the library is unique. As will be recognized by one of ordinary skill in the art, in practical applications and in most uses of such a strategy, sequences appear multiple times. Therefore, if such strategies were applied to multiplexed genotyping, individual alleles appearing many times within the overall population could not be correctly linked to their parent specimen.

Thus there is a need for a pooling pattern that would reveal unique specimen identities even in the face of redundancy. A multiplexing framework is required that relies on encoding the identity of the source of each sequence read within a pooling scheme rather than by directly barcoding individual samples results in a scheme where the number of pools is much smaller than the number of specimens. Thus, the number of barcodes required and the number of sequencing templates is greatly reduced. The present invention provides an inventive method that genotypes pools of specimens on a next-generation sequencing platform that approaches the sequencing capacity, while reducing the number of barcodes and maintaining a faithful detection of the affected specimens.

### SUMMARY OF THE INVENTION

To circumvent the previous limitations, according to one embodiment of the present invention a novel multiplexing framework is provided in which the identity of individual specimens is not encoded directly by an appended barcode sequence. Instead, specimen identities are encoded by positional information created by an optimized series of pooling, where integrating information from different pooling patterns is used to determine specimen identity.

As one example of an application of the present invention, more than 100,000 different samples can be analyzed using only a few hundred barcodes (e.g. 384). According to one example of the present invention, the approach relies on highly parallel oligonucleotide synthesis to generate mixtures of ˜22,000-55,000 different species that are adapted and ligated into expression vectors, which are pooled and barcoded.

According to one embodiment of the present invention, while each individual pooling pattern might yield multiple solutions to the link between sequence and specimen source, the combination of all pooling patterns would provide sufficient constraints that only a single, high-confidence solution would emerge for the vast majority of samples.

According to one embodiment of the present invention, a method is presented that permits simultaneous analysis of tens of thousands of specimens. The inventive method relies on the use of combinatorial pooling strategies in which pools rather than individual specimens are assigned barcodes. Thus, the identity of each specimen is encoded within the pooling pattern rather than by its association with a particular sequence tag.

According to an additional embodiment of the present invention, decoding the pattern allows the sequence of an original specimen to be inferred with high confidence.

### BRIEF DESCRIPTION OF THE DRAWINGS

FIG. 1 shows common techniques in next generation sequencing. In FIG. 1A, high throughput sequencing is employed by immobilizing DNA fragments (rods) on a slide and using sequencing reagents (black ovals) that generate optical signals. FIG. 1B show DNA barcoding based on synthesizing short DNA sequences, in the example ‘AAA’ and ‘GGG,’ and ligating them to the samples in distinct reactions. When the samples are mixed the barcodes maintain the identities of the specimens.

FIG. 2 illustrates a problem of non-unique genotypes in simple row/column strategies.

FIG. 3 depicts an example of pooling design according to one embodiment of the present invention.

FIG. 4 illustrates one example of a pooling scheme according to an embodiment of the present invention.

FIGS. 5A and 5B illustrate one example of decoding according to one embodiment of the present invention.

FIG. 6 illustrates one example of the pattern consistency decoder according to an embodiment of the present invention.

FIG. 7 illustrates simulations of decoder performance in different CRT pooling designs with 40,320 specimens according to one embodiment of the present invention.

FIGS. 8A and 8B depict simulation of the expected decoding results of shRNA library of 42,320 specimens with 1000 possible fragments and different pooling designs according to an embodiment of the present invention.

FIG. 9 depicts the number of sequence reads in each pooling window according to a test of one embodiment of the present invention.

FIG. 10 depicts Barcode abundance in the 384 pooling window according to a test of one embodiment of the present invention.

FIG. 11 depicts Barcode abundance in the 383 pooling window according to a test of one embodiment of the present invention.

FIG. 12 depicts Barcode abundance in the 381 pooling window according to a test of one embodiment of the present invention.

FIG. 13 depicts Barcode abundance in the 379 pooling window according to a test of one embodiment of the present invention.

FIG. 14 depicts abundance in the 373 pooling window according to a test of one embodiment of the present invention.

FIG. 15 depicts the prevalence of states as number of windows according to according to a test of one embodiment of the present invention.

FIG. 16 depicts results of testing one embodiment of the minimal discrepancy decoder according to an embodiment of the present invention.

FIG. 17 shows a Cystic Fibrosis ΔF508 screen as a bipartite multigraph reconstruction. There are two allele nodes, the WT and the ΔF508 mutation. Samples 1, 2, 3, 5 are WT, while specimen 4 is a carrier. The specimen labeled with ‘X’ is a carrier and does not enter to the screen. Eᵣᵢₛₖ is the edge between specimen 4 and the ‘Mut’ node.

FIGS. 18A and 18B show an example of a factor graph for genotyping reconstruction.

FIG. 19 shows the effect of damping on oscillations.

FIG. 20 shows decodability as a function of number of carriers.

FIG. 21 shows a simulation of a CF screen and the effect of β and confounding errors.

FIG. 22 shows different weights for CF ΔF508 screen detection.

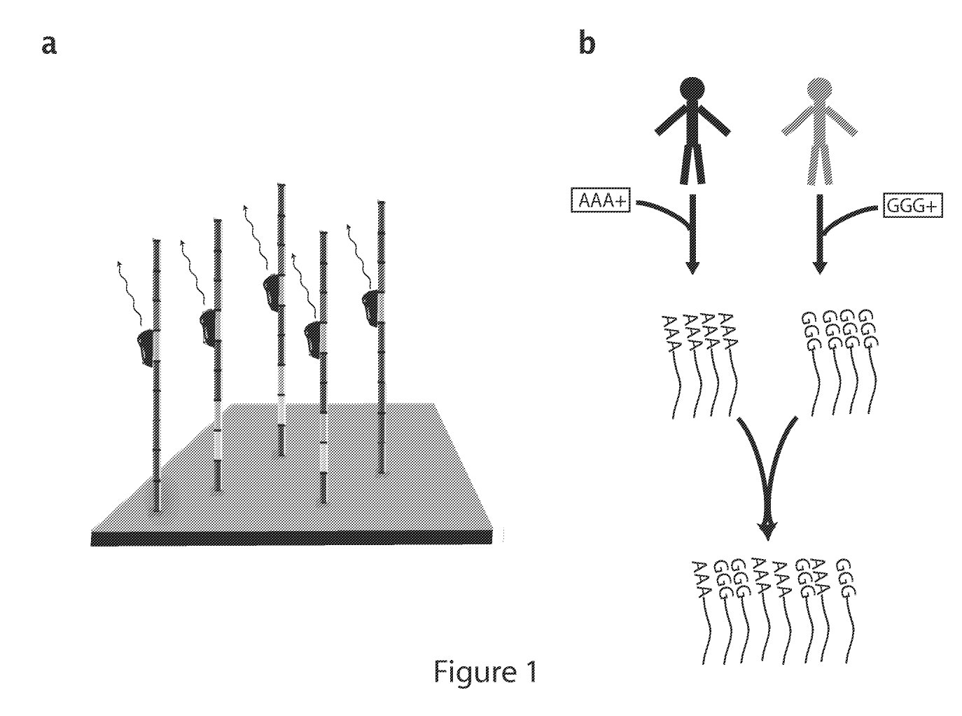

### DETAILED DESCRIPTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

In the following description, reference is made to the accompanying drawings that form a part of the present disclosure, and in which are shown, by way of illustration, specific embodiments of the invention. These embodiments are described in sufficient detail to enable those skilled in the art to practice the invention, and it is to be understood that other embodiments may be utilized and that structural and other changes may be made without departing from the scope of the present invention. The present disclosure is, therefore, not to be taken in a limiting sense. The present disclosure is neither a literal description of all embodiments of the invention nor a listing of features of the invention that is present in all embodiments.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “some embodiments,” and “one embodiment” mean “one or more (but not all) embodiments of the present invention(s)” unless expressly specified otherwise.

The terms “including,” “having,” “comprising” and variations thereof mean “including but not limited to,” unless expressly specified otherwise.

The term “consisting of” and variations thereof mean “including and limited to,” unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The terms “a,” “an” and “the” mean “one or more,” unless expressly specified otherwise.

Headings of sections provided in this patent application and the title of this patent application are for convenience only, and are not to be taken as limiting the disclosure in any way.

By way of introduction, the subject matter of the present invention relates to group testing and compressed sensing, which deals with efficient methods for extracting sparse information from a small number of aggregated measurements. Much of the group testing literature is dedicated to the prototypical problem, which describes a set of interrogated items that can be in an active state or an inactive state and a test procedure, which is performed on pools of items, and returns ‘inactive’ if all items in the pool are inactive, or ‘active’ if at least one of the items in the pool is active. Mathematically, this type of test can be thought of as an OR operation over the items in the pool, and is called superimposition. In general, there are two types of test schedules: adaptive schedules, in which items are analyzed in successive rounds and re-pooled from round to round according to the accumulated results, and non-adaptive schedules where the items are pooled and tested in a single round. While in theory adaptive schedules require less tests, in practice they are more labor intensive and time consuming due to the re-pooling steps and the need to wait for the test results from the previous round. For that reason, non-adaptive schedules are favored, and have been employed for several biological applications including finding sequencing tagged sites in yeast artificial chromosomes (YAC), and mapping protein interactions.

Compressed sensing is a signal processing technique that describes conditions and efficient methods for capturing signals that are sparse in some ortho-normal representation by measuring a small number of linear projections. This theory extends the framework of group testing to the recovery of hidden variables that are real (or complex) numbers. Additional differences from group testing are the aggregated measurements report the linear combination of the data points and not superimposition. However, some combinatorial concepts in group testing were found useful also for compressed sensing, and it has been recently shown that deterministic designs based on group testing can confer sublinear reconstruction runtimes for real signals. The framework of compressed sensing was also found useful for applications beyond “traditional” signal processing, and recently, a novel biological application was suggested—designing highly efficient microarrays that reduce the number of DNA probes, which is a factor hampering their miniaturization.

According to one embodiment of the present invention, the inventive method combines lessons from both fields, but also has key differences from these frameworks. The most obvious deviation is that rather than focusing solely on maximal reduction in the number of queries (termed ‘measurements’ in compressed sensing, or ‘tests’ in group testing), additional cost functions are introduced. Principally, the present invention achieves the additional objective of minimizing the weight of the design, corresponding to the number of non-zero elements of the design matrix (for a fixed number of specimens). This constraint originates from the properties of next generation sequencers, and prevents maximal query reduction.

According to one embodiment of the present invention, to the maximize the information capable of being encoded within a series of pooling patterns, one aspect of the inventive method utilizes the Chinese Remainder Theorem (CRT) as a pooling scheme. This approach is scalable, robust to both redundancy and sequence error (missing information), and is easy to debug. The framework is firmly rooted in information-theoretic nonadaptive group testing methodology. Yet, the present invention is the first application of CRT in NGST.

While taking advantage of these theoretical tools, methods formed using these tools generate physical overhead of creating pools and the costs that factor into robotics and pool analysis, namely next-gen sequencing. Consequently, the present invention provides an efficient method that minimizes cost and labor within the range of states and specimens sought for analysis, specifically multiple tens of thousands.

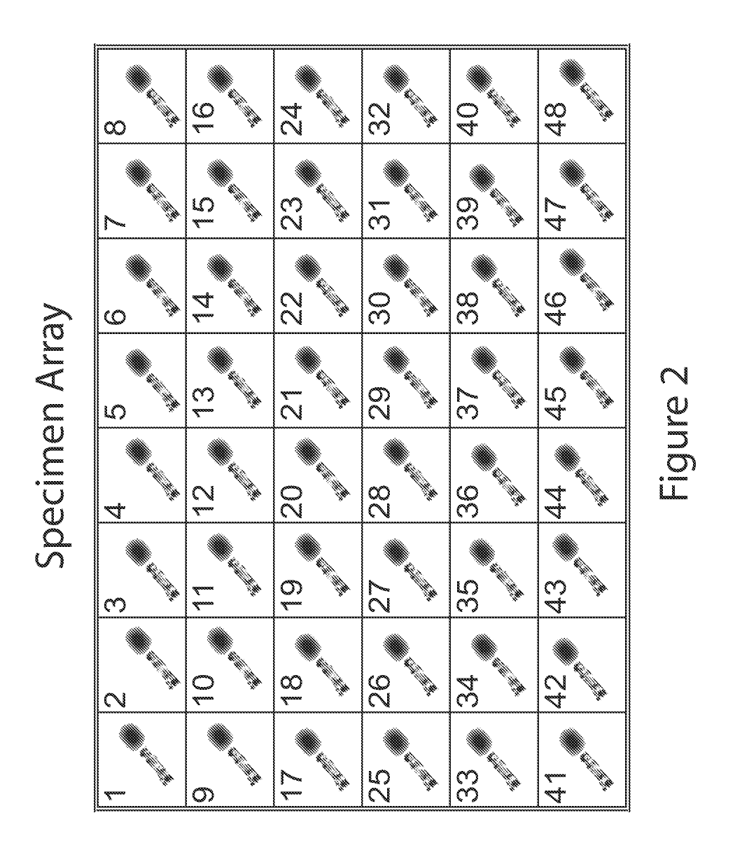

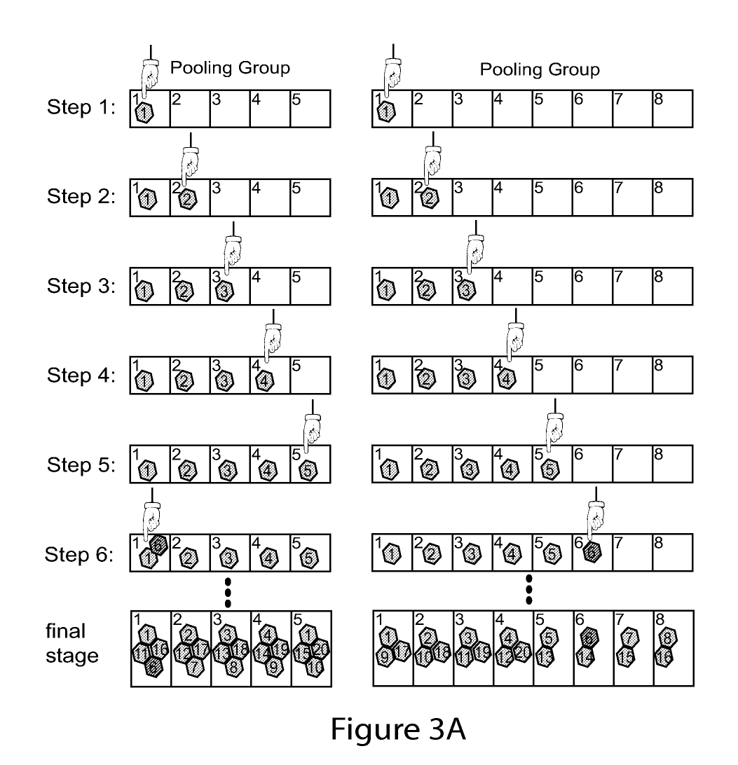

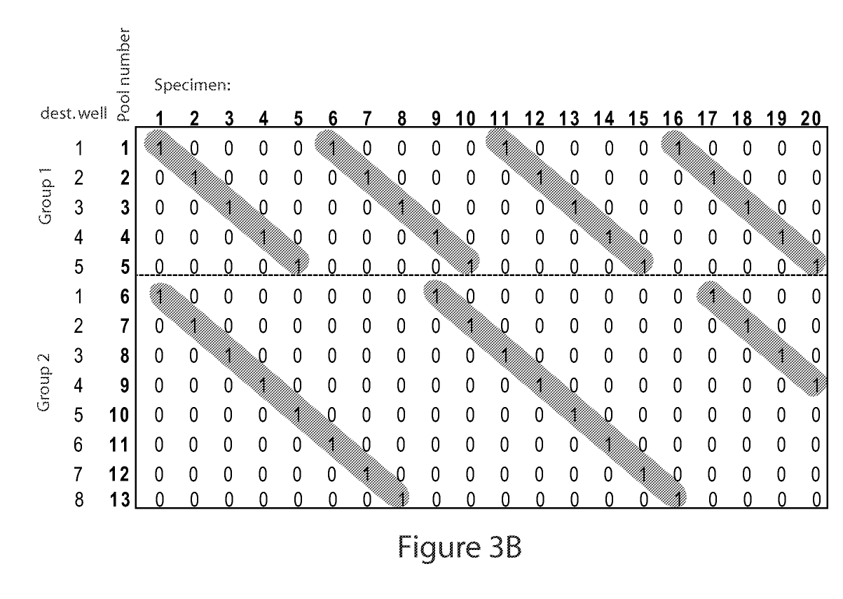

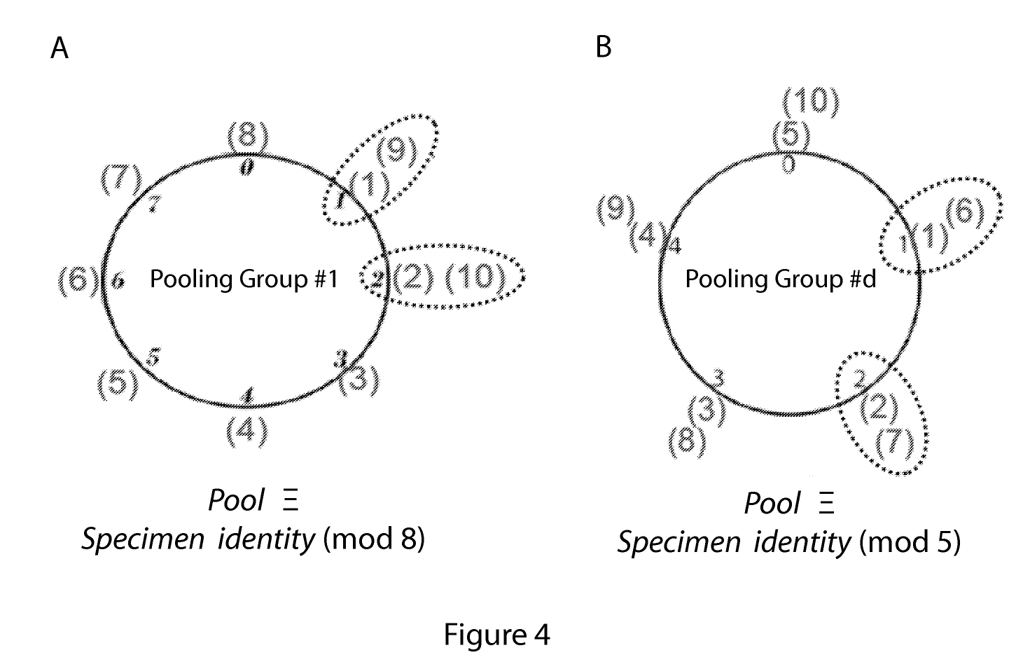

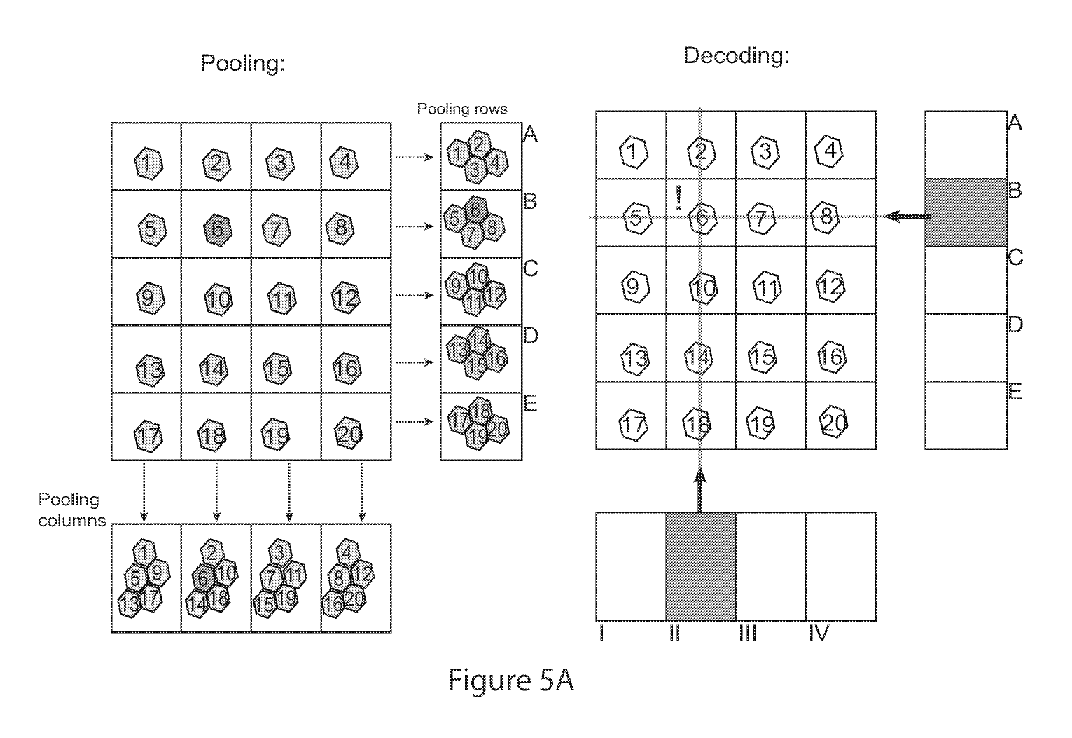

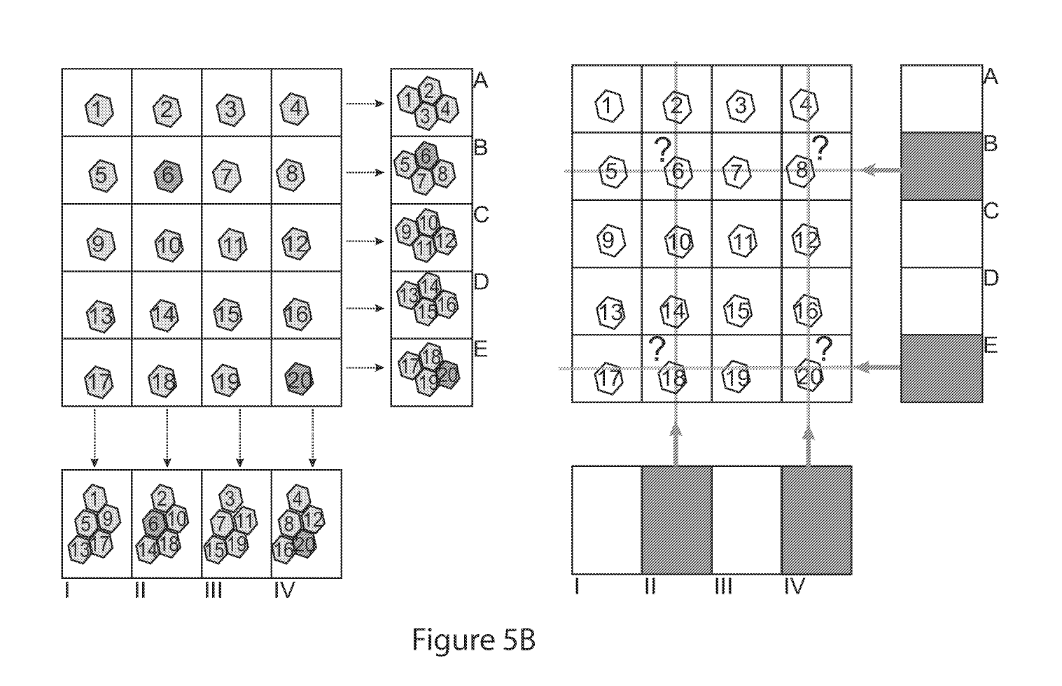

As one example of the present invention, referring to FIG. 2, the inventive method begins with N specimens that are arrayed in source wells, for instance, a series of 96 well plates. During a pooling step or combinatorial pooling step, aliquots of specimens are selected from the source wells to T destination wells, each of which accommodates a specific pool. According to one embodiment, referring to FIGS. 3 and 4, specimens are selected according to a deterministic method, such as a modulo pattern. In one embodiment, the modulo pattern of selection is determine according to the CRT. According to additional embodiments, the specimens are selected randomly.

Each pool, rather than each specimen, is tagged with a unique identifier, for example a unique sequence of DNA base pairs. The pools themselves are further mixed into one group or a small number of groups that are then analyzed by NGST. Data from the sequencing run is fed to a decoder, which solves the encoding pattern and generates a list of individual specimens and their corresponding inferred sequences.

The ability to achieve a solution according to the present method requires tracking specimens within the context of each pooling pattern and relating results generated by different pooling patterns. Since specimens may give rise to many sequences (e.g. fragments of a genome) and since specimens may be non-uniform at any sequence position (e.g. mixed samples or heterozygosity), each specimen may be defined as having a state, which is inherent in its sequence.

The information content of each pooling pattern is strongly related to the diversity of states among the specimens. Considering extreme examples, if states are identical among all specimens, then assignment of the common state is trivial. Alternatively if only one specimen has a state that differs from the others, it is straightforward to track its context in the different pooling patterns and work back to identify the source that gave rise to that state; in this case even a simple row-column pooling pattern as discussed in the background would be sufficient. If states are very common, for example if the specimens contain an equal mixture of two states, then it is extremely difficult to link contextual information from each pooling pattern to a specimen source.

According to one embodiment, the inventive method works best for linking relatively rare, albeit redundant, states to their source specimens. This is well suited to the goal of identifying clones representing individual oligonucleotides from high complexity mixtures. Additionally, this also indicates that the present invention would be suitable for identifying relatively rare polymorphisms within large populations.

Mathematical Analysis of Potential Approaches

The number of specimens that share the same state determines the ease in which identity can be encoded within pooling schema. According to on example of the present invention, redundant states are denoted with d₀. In a case with many states in the population, d₀ enumerates the largest group of specimens with the same state. In cases in which an allele exists in binary states, d₀ denotes the number of carriers for the rarer of the variants.

Overall, the lowest adverse impact of d₀ is achieved by minimizing the number of times any two specimens reside in the same pool within a series of pooling patterns. The pooling design can be represented by a pooling matrix M, which denotes the specimens residing in each pool. For example, referring to FIG. 3, the entries of the matrix are binary, either 0 or 1; the rows represent pools, and the columns represent the specimens. Thus, M is a T×N matrix. For example, if the first row is (1, 0, 1, 0, 1 . . . ), it specifies that the 1^{st}, 3^{rd}, 5^{th}, . . . specimens together occupy pool #1. The trivial case of one specimen, one barcode would yield the identity matrix I(N). C(i) and C(j) are two column vectors in M, corresponding to the pools associated with the i-th and the j-th specimens; w(i) denotes the weight of C(i), namely the number of pools in which a specimen is participating, essentially the number of 1's in the vector. λ(i, j)= [symbol] (C(i),C(j) [symbol] is the dot-product of the two vectors. The dot product reveals the number of intersecting pools that hold two particular specimens whose behavior is represented by the vectors.

The minimal weight, wₘᵢₙ and the maximal intersection λₘₐₓ of the pooling matrix are critical properties of the pooling design, defining the ability to identify a specimen whose state appears multiple times within the collection of samples. In information theory, this property is called d-disjunction and refers to the ability of a pooling design to convey sufficient information to guarantee fully correct decoding despite the presence of up to d specimens with the same state. It has been previously proved that a matrix with:

$$d = [ \frac{{w}_{min} - 1}{{λ}_{max}} ] \qquad ( 1 )$$

is d-disjunct. The present invention recognizes that an important goal is to minimize the difference between d₀ and d and when possible find a design were d>d₀. This can be achieved by increasing the weight or decreasing λₘₐₓ. In practical terms, increasing the weight has operational costs. According to one embodiment of the present invention, the method focused on minimizing λ, namely increasing the orthogonality between the column vectors. However, the present method envisions increasing the weight, decreasing the maximal intersection, or both.

According to one embodiment, the present method accomplishes an increase in d without adding more rows (pools) to the matrix, which would increase costs associated with pool preparation and sequencing. This task has been studied extensively in information theory and is related to the design of efficient error correcting codes. The difficulty of the task can be appreciated by considering λ=0, which denotes maximum orthogonality, and reducing the weight to the minimum for all columns, W=1. Basic linear algebra dictates that M is equivalent to the identity matrix T=N, which implies the one-specimen one-barcode framework. The theory of group testing suggests highly efficient methods that compromise W and to λ yield T˜ln N, essentially giving logarithmic growth of the number of barcodes in comparison to the number of specimens.

Practical Considerations for Efficient Pooling Designs

In practice, reducing the number of barcodes to the minimum is not the only requirement for effective multiplexing, since costs associated with labor and sequencing must also be considered. These are proportional to the weight, W. The weight determines the number of times each specimen is pooled and is related to the number of robotic steps, and thus cost in time and reagents, for pooling. According to one embodiment, the method uses a weight-balanced pooling design, where all the specimens are sampled the same number of times. The more times each specimen is added to a pooled library, the more the library size increases. Overall, the required sequencing coverage does not depend on the number of pools, but only on the weight of the design, which is a major deviation from the theory of group testing, where the only cost is associated with the number of pools.

Several additional biological constraints must also be taken into account, and these are related to the compression level R(t), the number of specimens that are participating in the t-th pool. High compression levels can reduce the efficiency and the reliability of the test, for instance PCR on a pool with thousands of specimens is prone to representation biases, elevating likelihood that some specimens will not be sufficiently sampled in the sequencing step. Experience has highlighted sufficient sequencing coverage as a key to the success of the decoding method, described in detail below. For example, according to one embodiment of the present invention, the pool size is limited to 1000 specimens.

Using combinatorial arguments, the inventive method demonstrates that pooling schemes with T˜\sqrt{N}, can minimize sequencing and robotic costs while still maintaining decoding robustness (d-disjunction) for clones with non unique states (see Supplementary Information). For comparison, T˜ln N methods that confer similar decoding robustness typically have weights that are at least two-fold higher than the achievable weight of T˜\sqrt{N} methods. In addition, the compression level of the T˜ln N methods is greater, creating more complex pools and potentially compromising performance in a biological setting. As one application of the present invention is genotyping thousands of specimens that can be non-unique in one Illumina GAII run, one embodiment of the present invention applies a T˜\sqrt{N} method.

Multiplexing Scheme

According to one embodiment of the present invention, a pooling rule is a modular equation. As one example, referring to FIGS. 3A, 4A and 4B, the figure illustrates pooling of 20 specimens according to the following two pooling rules:

### Example 1

$$[ \begin{matrix}n ≡ {r}_{1} ( mod 5 ) \\ n ≡ {r}_{2} ( mod 8 )\end{matrix} ]$$

For each pooling rule a destination plate is created, which accommodates the pools that are created based upon the rule. More generally, each pooling rule n has the following format:

n=r(mod x) (2)

which brings aliquots of the r, r+x, r+2x, . . . specimens to the r^{th}-well in the corresponding destination plate, where 0<r≦x, and x is called the pooling window. Let the pooling group be a set of all pools that are created according to a given x pooling window. According to one embodiment, the inventive method employs a system of W pooling rules:

$$[ \begin{matrix}n ≡ {r}_{1} ( mod {x}_{1} ) \\ n ≡ {r}_{2} ( mod {x}_{2} ) \\ ⋮ \\ n ≡ {r}_{w} ( mod {x}_{w} )\end{matrix} ] \qquad ( 3 )$$

The total number of the wells in the pooling groups gives the overall number of pools:

T=x₁+x₂+ . . . +x_{w}. (4)

For instance, in the example above we see that T=5+8=13.

This representation of the pooling scheme by the pooling matrix, M, has the following characteristics. Referring to FIG. 3B, for example, first, the rows of the matrix are partitioned to W regions, so that the first region has x₁ rows, the second region x₂ rows, with the pattern repeating until the number of pools is reached. In every region, the first row has a T entry in the first column. ‘1’ appears again after every increment that corresponds to the size of the corresponding pooling window; in the second row, the ‘1’ entry starts at the second column In this way, a staircase pattern in every region is generated. The pooling design has a weight of W, since every specimen is sampled only once in every pooling window, and the matrix is weight-balanced. In addition, the total number of T entries in every region of the matrix is the same. Thus, the sequencing capacity that is needed for each pooling group is the same.

A crucial element in maximizing the efficiency of such a design is the choice of the pooling windows: x₁, x₂, . . . , x_{w}. According to one embodiment, the pooling windows are chosen according to the CRT. According to additional embodiments the pooling windows are chosen such that the least common multiplier of any pair of pooling windows, i.e. the product of the pair of pooling windows divided by their greatest common factor, is greater than N.

According to one embodiment, the pooling rules of the present invention were designed to satisfy two basic requirements. First, the size of every pooling window was chosen to be greater than the square root of the number of specimens. Second, every set of pooling intervals was designed, according to the CRT, be co-prime with respect to each other. This means that no two pooling windows can have common factor other than 1. For instance, (7,9,10) are co-prime, but (6,9) are not co-prime because 3 is a common factor. These two requirements are denoted by the following equations:

x₁,x₂, . . . ,x_{w}:x≧\sqrt{N} (5)

{xᵢ,xⱼ},i≠j:xᵢ,⊥xⱼ (6)

When these two conditions are applied, The CRT asserts that any two column vectors in the pooling matrix intersect at most 1 time. Thus,

λₘₐₓ=1 (7)

gives the minimal possible intersection for any pooling design of T<N and confers the highest likelihood of detecting the state of each specimen. From (1) and (8) the decoding robustness of our pooling design is maximal and equals:

d=w−1 (8)

Example 1 follows these two requirements since (5,8) are co-prime, and 5≧\sqrt{20} 8≧\sqrt{20}, and d=1, guaranteeing correct decoding when all states are unique

Eq. 5 implies that the maximal compression level is:

Rₘₐₓ≦\sqrt{N} (9)

providing a very sparse compression that will never exceed 230 specimens for most situations (N<50,000). Equation 5 can be derived from the total number of pools according to one example of the present method:

T≈W\sqrt{N} (10)

As will be understood, the present invention may be implemented with other pooling designs other than CRT, including but not limited to, random pool selection, shifted transversal design, and Chinese Remainder Sieve.

Decoding Combinatorial Pooling—General Principles

Solving the combinatorial pooling is a matter of determining which pooling patterns for a particular state coincide with the experimentally determined content of the pools, which were created by either deterministic or random selection. This can be understood most easily by considering a case of binary states, wherein each specimen is either a WT or a rare mutant. In this case, the task is to find the rare mutants. According to one embodiment of the present invention, to uncover the configuration that led to the observed pattern, the decoder eliminates specimens whose association with the mutant state would violate the observed pattern. This is achieved by scanning the pooling matrix along the pools (rows) that contain a mutant state and summing the columns of those rows, creating a histogram of specimen versus the number of pooling windows in which it appeared. If a specimen is mutant, the mutant state should appear in all windows harboring the specimen. Thus, any specimen with a level below W in the histogram is excluded. This histogram essentially displays the number of constraints fulfilled by associating the mutant state with each specimen. According to this embodiment of the present invention, this method of decoding shall be referred to as pattern consistency decoding.

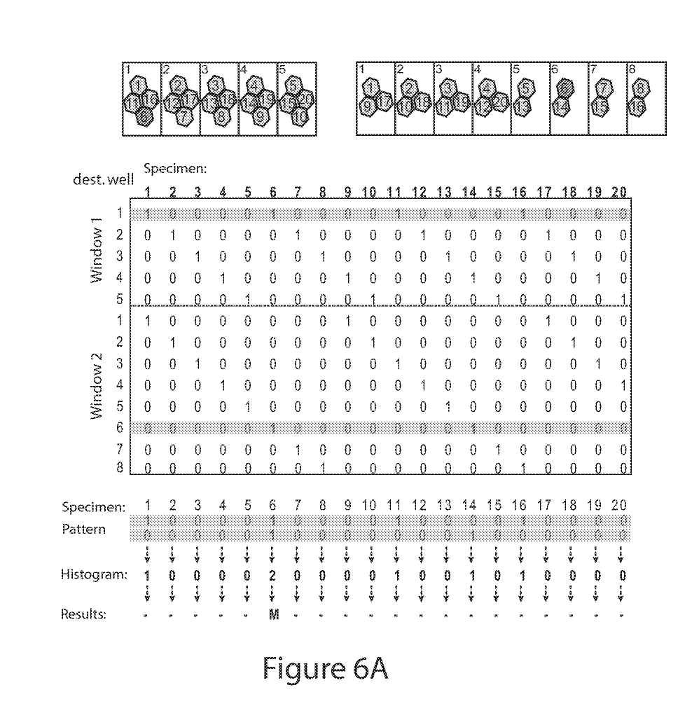

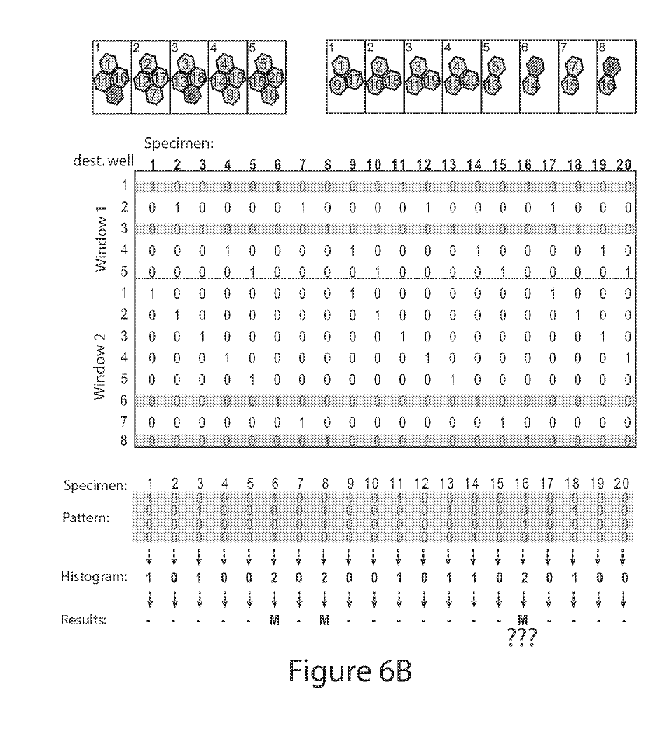

An example application of the inventive method disclosed above is detecting the presence of Tay-Sachs disease. For example (according to the example presented in FIG. 6A), if the goal is to determine whether any of twenty individuals are carriers for Tay-Sachs disease, the conventional detection process would involve performing twenty DNA tests, one for each individual. This can be extremely time consuming and expensive, and as would be clear to one of ordinary skill, the number of tests required according to individualized testing would grow linearly with the number of individuals. However, shown by the example in FIG. 6A, as long as no more than one of the twenty individuals is actually a carrier, that individual can be identified using the disclosed method by performing only two tests, instead of the twenty required by the conventional method. As will be appreciated, the following example will successfully identify any “rare” state, such as the presence of Tay-Sachs mutation, though it is not so limited. For example, the present invention may also be used to identify many alleles wherein each is found in low prevalence among the population.

The example provided in FIG. 6A is a continuation of the combinatorial pooling scheme shown in FIG. 3A. By way of example, as shown in FIG. 3A, a group of twenty blood samples may be collected from individuals to be tested for Tay-Sachs. After the requisite DNA has been removed from the blood samples for testing, the samples are separated into two pooling groups: the first pooling group is comprised of five pools, whereas the second pooling group is comprised of 8 pools. Referring to the pooling group 1 shown in FIG. 3A, the twenty samples are placed into each pool in a modulo fashion using 5 as the pooling window, where the 1^{st}, 6^{th}, 11^{th} and 16^{th} samples are selected and placed in the first pool, the 2^{nd}, 7^{th}, 12^{th}, and 17^{th} samples are selected and place in the second pool, and so on until each sample has been selected and placed in a pool. Referring to FIG. 3B, this selection method produces the pattern in the upper half of the matrix (above the dotted line), which corresponds to the first pooling group where a 1 in the matrix represents the presence of the sample in the pool.

After each pool has been created a unique marker is added to each pool to identify the samples in the pool. According to one embodiment, the unique marker is a short DNA sequence that is ligated to each sample with the pool.

Referring to pooling group 2 shown in FIG. 3A, the same twenty samples are again placed into pools in a modulo fashion. Here, the pooling group 2 is formed in a modulo 8 fashion, where pool 1 contains the 1^{st}, 9^{th}, and 17^{th} samples, the second pool contains the 2^{nd}, 10^{th} and 18^{th} samples, and so on until each sample has been selected and placed in a pool. Referring to FIG. 3B, this selection method produces the pattern in the lower half of the matrix (below the dotted line), which corresponds to the first pooling group where a 1 in the matrix represents the presence of the sample in the pool. As shown in the matrix in FIG. 3B, each sample appears in both pooling groups, albeit in different pools (excepting the first five samples).

Again, after each pool has been created, a unique marker is added to each pool to identify the samples in the pool. According to one embodiment of the present invention, while unique identifiers may not be reused for pools within the same pooling group the unique identifiers may be reused in subsequent pooling groups. Thus, there is only a need for a number of unique identifiers equivalent to the largest pooling window.

As shown in FIG. 3A, after each pool is formed for each of the pooling groups, the pools for each pooling group are combined, resulting in two pools, each containing all twenty samples. For example, pooling group 1 includes all 20 samples, but sample 1, 6, 11 and 16 have all be marked with one unique identifier, samples 2, 7, 12 and 17 have all been marked with a second unique identifier, and so on for each pool within the pooling group. As will be understood, additional pooling groups may be formed according to the methods described above and the selection of pooling windows described below.

The pooling windows chosen to form each pooling group may be selected in several manners. According to one embodiment of the present invention, each pair of pooling windows is different and co-prime, i.e., cannot share a common factor other than 1. For example, both 5 and 8 (the pooling windows used in the examples in FIGS. 3, 4 and 6) cannot both be divided by any number other than 1. According to additional embodiments, pooling window is larger than the square root of the number of samples. Again referring to the examples in FIGS. 3, 4 and 6, both 5 and 8 (the two pooling windows chosen in the example) are larger than 4.472, the square root of 20, the number of samples. According to additional embodiments, the least common multiplier of any pair of pooling windows is greater than the number of samples. The least common multiplier may be found by taking the product of the pooling windows and dividing the result by the largest common factor of both pooling windows. For example, the least common multiplier of 6 and 9 is

$$18 ( \frac{6 \cdot 9}{3} ) ,$$

which is not larger than the number of samples in the example (20) and would not work, however, if 9 and 12 were chosen as the pooling windows, the least common multiplier would be

$$36 ( \frac{9 \cdot 12}{3} ) ,$$

which would provide successful results. According to additional embodiments, constructing the pooling matrix is based on random design—picking random column vectors that have a constant weight (the concept of weight will be described later). Constructing the pooling matrix is not limited to those methods.

After the formation of each pooling group, the pooling groups are sequenced in a DNA sequencers, where each pooling group is sequenced separately. The results of the DNA sequencing produces a pattern of results that include a unique identifier and a state for each sample that was sequenced. For example, the DNA sequencer will produce a text file that includes a DNA sequence for each sample, where the text file indicates the unique DNA marker of the sample as well as whether the DNA sample indicates that the individual has Tay-Sachs. However, as can be appreciated, because the same unique identifier was used for each sample in a common pool, at this stage the results can only point to the pool (or pools) that contain a sample with Tay-Sachs and not the individual sample. To determine the sample with Tay-Sachs the results from the DNA sequencing for each pooling group are used to form a pattern that is used to decode the results and identify the sample with Tay-Sachs. An example of decoding of the DNA sequencing results is shown in FIGS. 6A and 6B.

FIG. 6A depicts successful decoding. Continuing with the example discussed above with respect to FIGS. 3A and 3B, this pooling matrix that was formed by the two pooling groups has decoding robustness of d=1 (where d=weight−1), i.e., the method guarantees proper assignment of state if up to one sample containing Tay-Sachs is present in the specimens. As described elsewhere, the weight of the pooling matrix is equivalent to the number of pooling groups used to form the matrix, which in the example in FIG. 6A is 2. As shown above the matrix, specimen #6 is the only sample with Tay-Sachs, therefore, the method guarantees that specimen #6 will be properly characterized.

After pooling and sequencing according to various embodiments described above and elsewhere in this specification, the only data available for the decoder is the following pattern produced from the DNA sequencer: a specimen with Tay-Sachs is present in the 1^{st} pool of the first pooling group (or pooling window) and in the 6^{th} pool of the second pooling window depicted by the highlighted rows in the matrix. This pattern is shown highlighted both on the original pooling matrix as well as below the matrix for ease of reference.

This pattern is known because the DNA sequence provides the state of the specimen (Tay-Sachs or no Tay-Sachs) and the unique identifier associated with the pool from which the specimen came. According to the pattern in the figure, if the sample is found to have Tay-Sachs a “1” is entered in the matrix corresponding to the pool containing the specimen with Tay-Sachs. As will be understood, the sequencer provides information that a specimen with Tay-Sachs and the unique identifier associated with pool #1 is present, therefore a “1” is entered in each position of the pattern corresponding to a specimen selected for pool 1.

According to one embodiment of the present invention, referring to the pattern at the bottom of FIG. 6A (the highlighted rows), summing along each of the columns of the pattern (as depicted by the downward pointed arrow) creates a histogram that represents the number of windows in which a specimen with Tay-Sachs (the characteristic of interest) was found. The histogram is represented below the pattern at the bottom of FIG. 6A.

The histogram is representative of the number of constraints each sample satisfies (e.g., treating each pooling window as an equation, the number of equations satisfied by the sample). As shown in this example, the scores of the histogram range from 0 to the weight of the matrix, which is 2. Again, the weight of the matrix is equal to the number of pooling groups used in the sequencing methodology.

According to one embodiment of the present invention, the pattern consistency decoder establishes a threshold equivalent to the weight of the matrix and assigns Tay-Sachs only to specimens with a histogram value equal to the threshold—samples meeting this condition appeared in all windows (i.e., have a value in the histogram equivalent to weight of the matrix). Referring again to the example in FIG. 6A, since only specimen #6 has a score of 2 in the histogram—meaning it appeared in all possible windows—it is associated with Tay-Sachs, and the decoder reports the correct result.

FIG. 6B depicts an example of a failure in decoding. Continuing with the example discussed above with respect to FIGS. 3A and 3B, this pooling matrix that was formed by the two pooling groups has decoding robustness of d=1 (where d=weight−1), i.e., the method guarantees proper assignment of state if up to one specimen with Tay-Sachs is present in the specimens. However, as shown above the figure, according to the example in FIG. 6B, both specimens #6 and #8 have Tay-Sachs (d₀=2). Thus, in the example, correct decoding is not guaranteed because, as described elsewhere, d₀>d.

After pooling and sequencing according to various embodiments described elsewhere in this specification, the only data available for the decoder in this example is the pattern indicated in the matrix, indicated by the highlighted rows in the matrix. For ease of reference, this pattern is also reproduced below the matrix. Again, the pattern shown on the matrix is known because the DNA sequence provides the state of the specimen (Tay-Sachs or no Tay-Sachs) and the unique identifier associated with the pool from which the specimen came. According to the pattern in the figure, if the sample is found to have Tay-Sachs a “1” is entered in the matrix corresponding to the pool containing the specimen with Tay-Sachs. As will be understood, the sequencer provides information that a specimen with Tay-Sachs and the unique identifier associated with pool #1 is present, therefore a “1” is entered in each position of the pattern corresponding to a specimen selected for pool 1.

Referring to the pattern at the bottom of FIG. 6B (the highlighted rows), summing along each of the columns of the pattern (as depicted by the downward pointed arrow) creates a histogram that represents the number of windows in which a specimen with Tay-Sachs (the characteristic of interest). As shown in this example, associating specimen #16 with the mutant state is consistent as the score shown in the histogram is equal to the weight of the matrix. However, while this decoding result is consistent with the pattern, the reported state of specimen #16 is incorrect. Recall, because the number of specimens with Tay-Sachs is greater than the robustness of this combinatorial pooling selection, the correct assignment of Tay-Sachs to each specimen with the disease is not guaranteed.

As shown by the example in FIG. 6B, according to the pattern consistency decoder embodiment of the present invention, the decoder will associate states with the specimens by finding the maximal configuration consistent with the sequencing data. According to various embodiments, the decoder will err in favor of assigning a mutant state (Tay-Sachs) to a wild-type specimen (normal) as each specimen may subsequently be tested individually. As shown by the example in FIG. 6B, this is more efficient than testing each of the 20 samples individually: rather, the failure in decoding in the example will only require 5 tests—one for each pooling group and one for each of the specimens associated with Tay-Sachs by the decoding method, i.e., testing each of the two pooling groups and then subsequently individually testing specimens 6, 8 and 16, results in a total of 5 tests.

Pattern consistency decoding definitively provides correct configuration when the number of mutant specimens, d₀, is less than or equal to d. Referring to FIG. 6B, when d₀ is higher than d several configurations of specimen identity become consistent with the pattern. Hence, many specimens may falsely be reported as mutant. In practice, when the difference between d₀ and d is not high, pattern consistency decoding still reveals the correct specimen identities with high probability.

Pattern consistency decoding for multiple states takes a similar approach. In each round the decoder takes one state and analyzes it as if it was the binary case, excluding its association with specimens that would contradict the observed pattern of that state. At the end of the round, the decoder adds the interrogated state to their list of possible states for specimens that were found to be consistent. At the end of a completely successful decoding, each specimen is associated with exactly one possible state. When d₀ of the interrogated state is too high, this state may appear as a false positive associated inappropriately with a number of specimens. Since the specimens' true state will also be associated with the same specimens, they are ultimately reported by the decoder as ambiguous.

The inventors of the present method have verified the ability of the disclosed encoding and decoding methods to accurately report the sequence of individual samples within a large number of mixed specimens in two ways. First, the inventors simulated data both from a clone library and from a human population in which a sequence variant associated with cystic fibrosis was present. Second, the inventors pooled, sequenced, and decoded identities within two sets of 40,000 bacterial clones comprising ˜20,000 different artificial MicroRNAs targeting Arabidopsis or human genes. The inventors achieved greater than 97% accuracy in these trials.

Under one testing scenario, the inventors chose to determine states by sequencing the output of one pooling rule in one lane of an Illumina GAII. Thus, it is possible to reuse the same set of barcodes/oligonucleotides in each pooling group, reducing the number of barcodes needed to around \sqrt{N} for small W.

For the number of specimens that were envisioned (N<50,000), the inventors analyzed the differences in number of barcodes required for the T˜\sqrt{N} scheme to the theoretically oriented T˜ln Eppstein method. Results are shown in Table 1, below.

TABLE 1

| | Decoding | Eppstein | | | Combinatorial Pooling | | |
|---|---|---|---|---|---|---|---|
| #Specimens | Robustness (d) | Pools | Weight | Barcodes | Pools | Weight | Barcodes |
| 5,000 | 3 | 149 | 10 | 29 | 293 | 4 | 77 |
| | 4 | 237 | 12 | 37 | 370 | 5 | 77 |
| | 5 | 336 | 15 | 47 | 449 | 6 | 79 |
| 40,000 | 3 | 209 | 12 | 37 | 811 | 4 | 205 |
| | 4 | 335 | 14 | 47 | 1020 | 5 | 209 |
| | 5 | 472 | 17 | 59 | 1231 | 6 | 211 |

Eppstein's construction was chosen as a reference for several reasons. The method has the maximal reduction in pool number and shows the best general performance among information theoretic methods. Moreover, the construction is also based on the CRT, but without asserting that the number pooling windows be greater than the square root of the number of specimens. It is assumed that each pooling group is sequenced in one Illumina lane and that the number of barcodes needed is equivalent to the maximal number of pooling windows in each method.

Eppstein's method reduces the number of pools, however, this comes at the cost of heavily increasing the weight of the design, and thus sequencing and robotic costs. For example, the analysis of 40,000 specimens (see below) required less than one Illumina GAII flowcell (5 lanes), whereas Eppstein's method would consume more than two full flow cells (17 lanes). The increase in the number of barcodes required was not dramatic, ˜150 in the worst case.

Simulated Datasets: Decoding Clone Collections and Identifying Variants within a Population

The performance of combinatorial pooling according to the present invention was tested with pattern consistency decoding for two simulated scenarios that matched several interests. In the first, the inventors sought to identify and verify shRNA inserts harbored by a large number of bacterial clones. In the second, the inventors sought to identify carriers of a rare genetic disease amongst a large number of individuals. In both cases, the inventors limited the number of pooling windows to 8, so that sequencing could be carried out on one Illumina GAII flow cell.

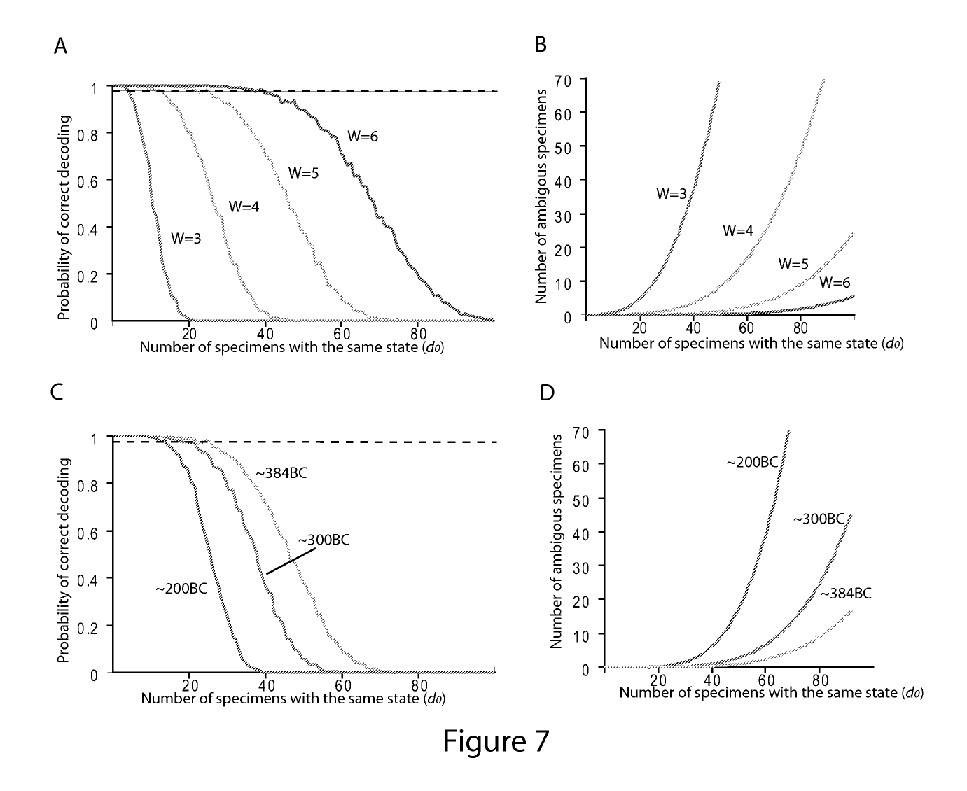

In the shRNA scenario, 40,320 simulated bacterial clones carried one of 12,000-17,000 possible inserts, a number consistent with array-based oligonucleotide library synthesis. Based upon prior experience, the inventors estimated d₀ to be no more than 40-50, even in the presence of biased cloning. Given these parameters, the inventors simulated the effect of number of pooling windows, the results of which are shown in FIGS. 7A-B, and the number of barcodes on the decoding performance, shown in FIGS. 7C-D. Evaluating the probability of achieving unique assignments as a function of d₀, strong transitions were notes when d₀ passed a certain threshold, depending upon the pooling design. The inventors also determined the number of ambiguous assignments for different values of d₀. These measurements were used in a relatively qualitative manner to understand the effect of adding pooling windows or increasing the number of barcodes used within our scheme. The inventors discovered that each additional pooling window reduced the remaining uncertainty substantially, while adding barcodes had modest effects. These observations could be used to construct a rough heuristic to determine the number of barcodes and windows required to analyze a set of samples of a particular size and complexity. In comparison to a random k-set design method, the number of unrelated specimens for different inputs is typically smaller by 25%. This supports the value of using Eppstein's analytical equations as an upper bound for the optimization process instead of exhaustively simulating large numbers of instances.

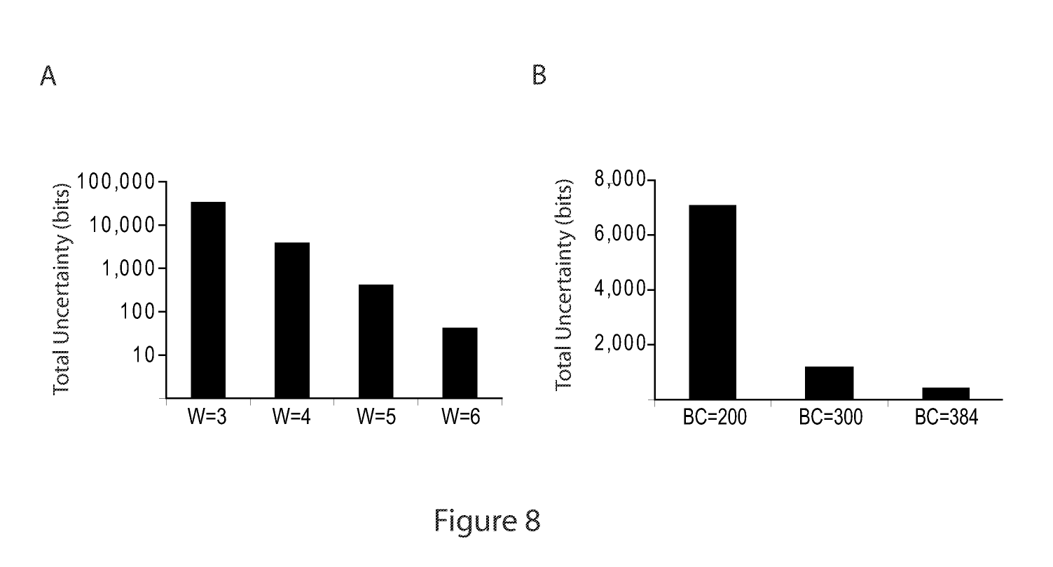

As a stringent test, the inventors also validated the performance of the decoder when faced with an input set of 40,320 specimens distributed amongst only 1,000 different states, which corresponds to d₀≈60. The results are shown in FIG. 8.

To estimate the value of combinatorial pooling for the analysis of rare variants in individuals, the inventors presented the process with a population in which were segregated two prevalent Cystic Fibrosis risk alleles, CFTR mutations ΔF508 (MIM: 602421.0001) and W1282X (MIM: 602421.0009). The inventors set the carrier frequency of each allele according to levels found in a large cohort analyzed by the Israeli CF screening unit, ˜1.8%. This relatively high frequency of risk alleles challenges combinatorial pooling, testing the present method against a difficult genetic screening problem.

The simulation included 18,000 individuals that were either homozygous wild type or heterozygous carriers of risk alleles, translating to a d₀ of around ˜320. The inventors simulated 7 pooling windows with ˜384 barcodes. The inventors randomly sampled the pooled data and created artificial sequence reads that reproduce Illumina GAII sequencing error profiles, which are dominated by substitutions of C [symbol] A and G [symbol] T. The inventors used two methods to simulate sequencing errors. The first was based on an analysis of more than 30 million sequences of Phi-X from 3 different runs, and the other was based on a recent study of Druley et al. (2009).

In the case of ΔF508, the inventors simulated 4,000 reads for each pool which corresponds to 1.5 million reads per lane, a relatively low number for a GAII instrument. Before applying pattern consistency decoding, the inventors filtered reads that did not perfectly match to the WT or risk allele. In both error profiles, Phi-X based and human based, the sensitivity was 100% and the specificity was 98.2%. The case of W1282X was more complex since pools that essentially contain no carriers may report a presence of a carrier due to sequencing error. In order to distinguish between sequencing error and the presence of a true carrier in the pool, the inventors introduced a probabilistic threshold procedure to the pattern consistency decoder. This determined the expected ratio of carrier reads and the standard deviation for each pool if exactly one carrier were present in the pool. The threshold was set as three standard deviations below the expected value, and pools that passed the threshold were marked as containing at least one carrier. With the error profile based on Phi-X and 10,000 reads per pool (about 4 million per lane), the inventors reached sensitivity of 100% and specificity of 98.3%. Setting the threshold to two standard deviations below the expected value reduced the sensitivity to 98.1% and did not affect the specificity, meaning that false positives are not due to the sequencing errors but are due instead to a limitation of the pooling procedure in dealing with large d₀ values. The simulation-based on error profiles derived from human data revealed similar picture. Sensitivity was 100% and specificity was 97.9% with ˜10,000 valid reads per pool.

The inventors tested the effect of dramatically reducing sequence coverage using the human error profile. The inventors sampled 500 reads per pool (˜200,000 reads per lane), corresponding to only 5 reads per chromosome in each pool. Under those conditions, the sensitivity dropped to 98.7% and the specificity to 94.4%, changing the threshold to one standard deviation restored the specificity to 98.9% but reduced the sensitivity to 73.8%. These results not only highlight the importance of sufficient sequencing coverage in combinatorial pooling according to the present invention, especially for medical genetics applications but also demonstrate the robustness of the procedure under non-ideal conditions.

Using DNA Combinatorial Pooling to Decode Physical Clone Collections

The inventors next tested the ability of the combinatorial pooling method according to the present invention to identify and validate shRNA clones derived from two different multiplexed oligonucleotide synthesis runs. In the first case, the inventors synthesized 17,500 oligonucleotides representing artificial microRNAs (amiRNAs) targeting Arabidopsis genes. 40,320 bacterial colonies were picked into 96-well culture blocks using a Genetix QPIX. The goal was to determine and verify both the passenger of the >40,000 clones.

Creating the patterns of pooled samples is perhaps the most time consuming part of combinatorial pooling. The inventors, therefore, tuned the procedure for use on a Tecan liquid handling robot with a fixed-tip head that has 8 individually addressable pins. Use of washable pins extends robotic run times but eliminates the otherwise substantial cost for disposable tips. This type of system is in relatively common usage, but the logic underlying the optimization is sufficiently flexible to allow adaptation to other robotic platforms.

Considering practical constraints placed upon the procedure, it required the liquid handling robot approximately 45 minutes to move specimens from one source plate to one destination plate, with the majority of time being spent on tip washing. Thus, each additional pooling window added substantially to the overall pooling operation. At the present level of optimization, the creation of 5 pooling windows from ˜40,000 clones requires approximately 7-9 days, which the inventors consider reasonable. Most liquid handling stations can dispense into plates with up to 384 wells, placing this as an upper limit on the number of barcodes that could be conveniently used. Considering these practical constraints, the simulation results, and the expected d₀ level, the inventors decided to use a 5-window combination of pooling intervals: 384, 383, 381, 379, and 373, which provided a compromise between higher inference rates and tolerable robot time.

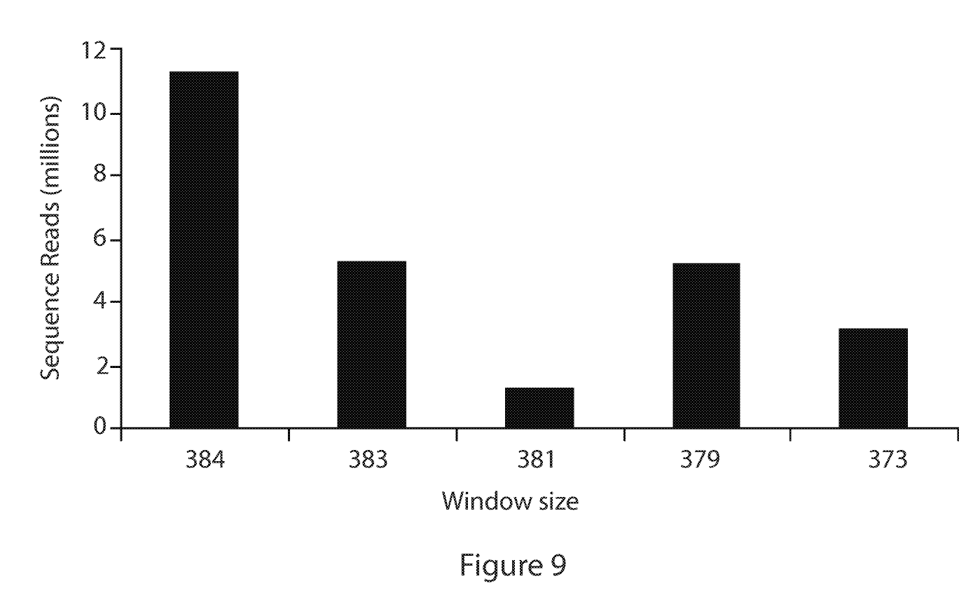

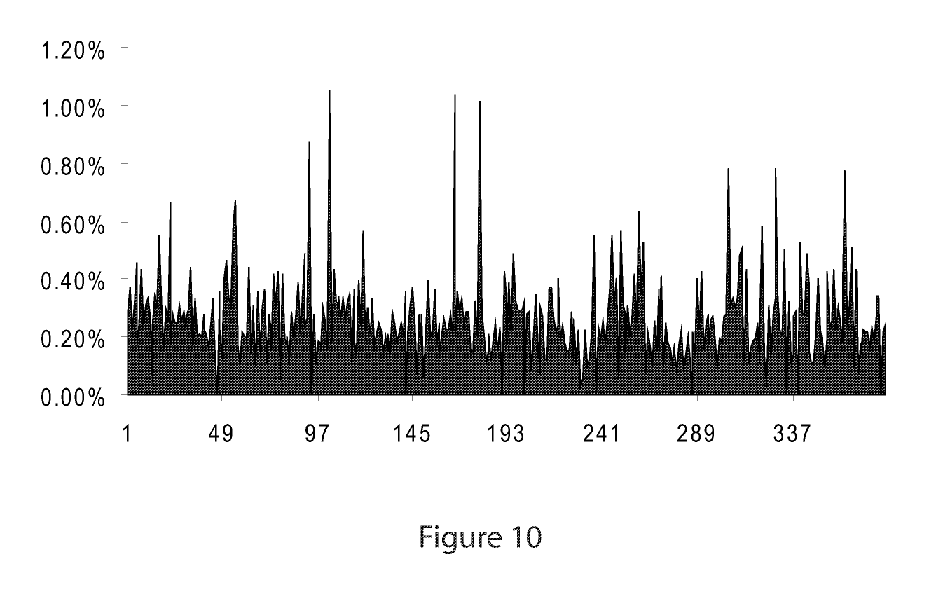

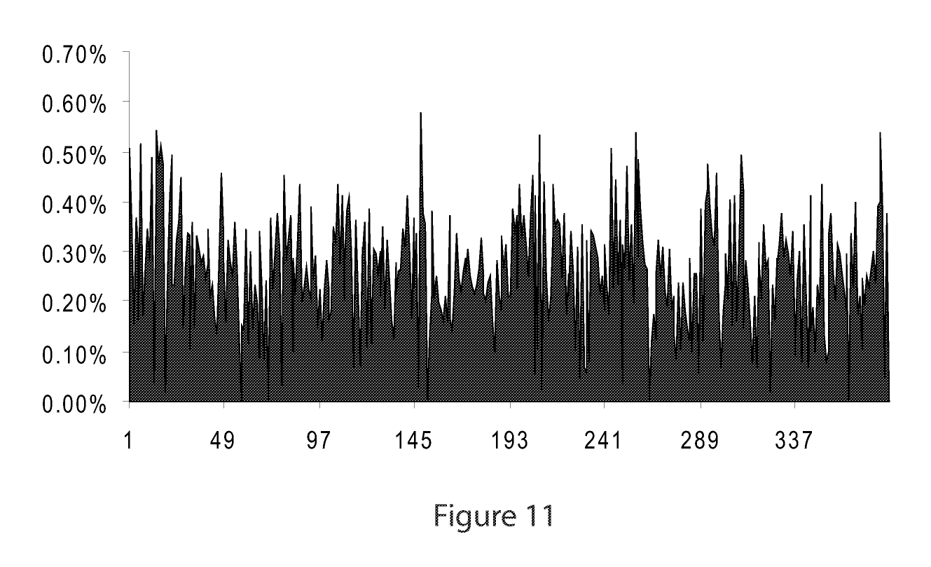

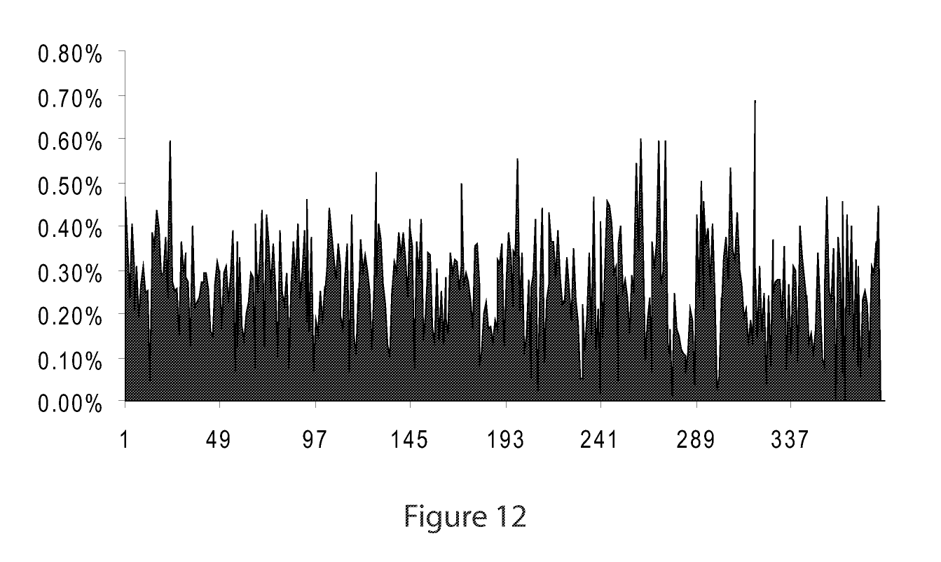

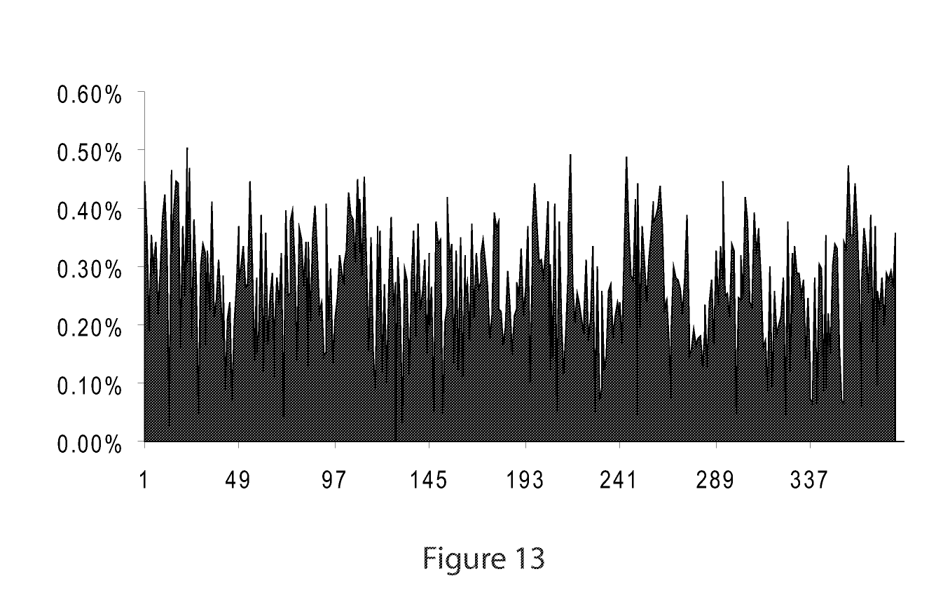

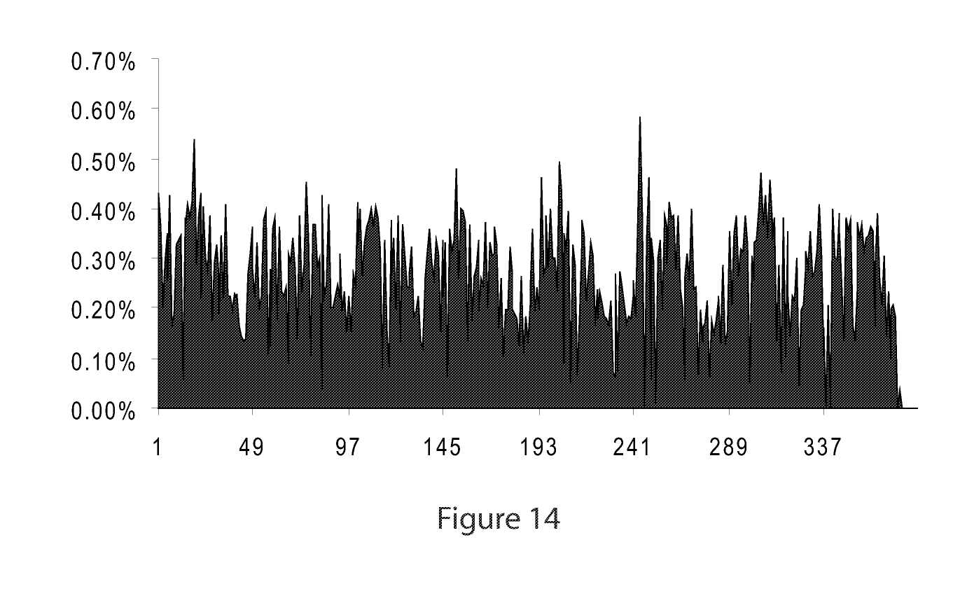

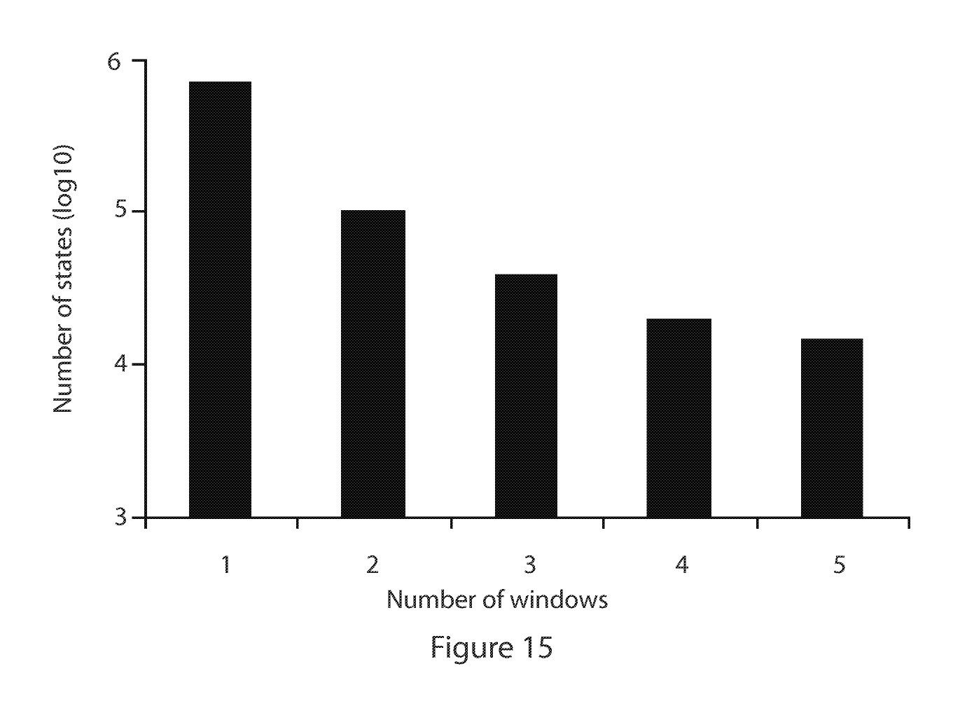

The inventors sequenced each pooling group in a separate lane of an Illumina GAII flow cell, obtaining a total of 25 million sequence reads. The inventors parsed the sequence reads and annotated the barcodes. Several practical challenges were emerged from the sequencing data. First, the number of reads where non-uniformly distributed among the different lanes shown in FIG. 9, with some lanes exceeding 10 million reads, and other reaching as low as 1 million reads, meaning 25 reads per specimen on average. A second challenge was low numbers of reads from specific pools, in particular the 13^{th} pool and repeatedly every 48 pools thereafter in most of the pooling groups, shown in FIGS. 10-14. This reflected inefficiencies in preparation of the sequencing templates in those wells. A third practical challenge, that was not simulated previously, was low-level contamination by sequences that appeared in up to several hundred pools and thus introduced significant “noise” into the decoding process. Finally, the inventors were faced with a large number of sequencing errors. The inventors found that the library had in total more than 800,500 possible states (i.e., distinct sequence reads), which exceeds by 20 fold the number of sequences used to program oligonucleotide synthesis—FIG. 15. Since the whole procedure was deployed to distinguish clones with synthesis errors versus correct clones, the inventors could not revert these sequence reads simply by aligning them to the design file.

In the face of these challenges, the pattern consistency decoder according to one embodiment of the inventive method performed remarkably well, providing 28,000 specimens with potential state calls, of which 20,500 specimens were unambiguous. To test the performance, the inventors compared the results of the decoding to a set of about 3000 specimens whose state had determined by conventional sequencing. This revealed that 95% of the 20,500 assignments were correct.

While the high decoding rate provided successful results, the inventors sought approaches to minimize the number specimens with empty or ambiguous lists, without sacrificing veracity. Based upon experience, the inventors developed a number of heuristics. First, the inventors increased tolerance for missing states when the sequencing depth for a particular pool was low and introduced penalties for states with low read numbers when sequencing depth was otherwise high. The inventors incorporated a priori knowledge of d₀ and penalized possible assignments that match to large numbers of specimens.

Thus, instead of hard consistency requirement, according to a further embodiment of the present invention, the inventors created a decoder that measures the discrepancy of the pattern from an ideal one, and registers that value. After evaluating all possible states, the decoder scans through specimens and assigns the state whose pattern exhibits the minimal discrepancy. In addition it reports an assignment quality score that is defined as the difference between the discrepancies of the best state to the second best state. Additional information regarding the several decoding methods according to the present invention is provided in Supplementary Information, appended to the present application.

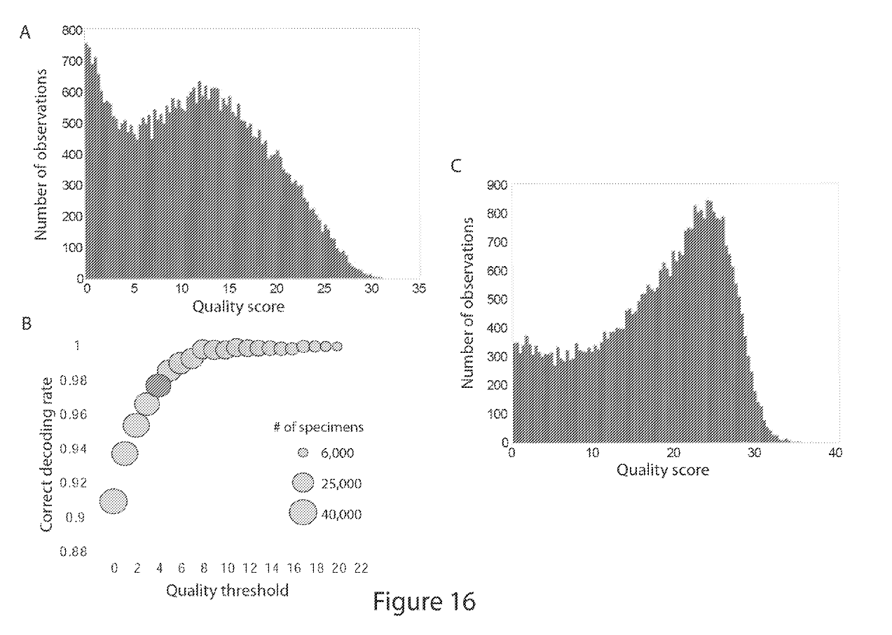

Analyzing the distribution of assignment quality scores revealed a bimodal distribution, shown in FIG. 16A, the inventors tested whether this corresponded to mediocre versus high-quality decoding. The inventors found an informative correlation between the quality scores to the correct decoding rates, shown in FIG. 16B, which resembled the bimodal distribution with strong transition around value of 5. The inventors, therefore, filtered specimens with quality scores below 5 and compared the remaining 31,000 specimens to the capillary reference. Correct decoding rates jumped to 98.5%. When the inventors removed quality filtration the correct decoding rate dropped to 91% for all 40,320 specimens. Thus, the improvement the inventors achieved using the minimal discrepancy decoder over the pattern consistency decoder was substantial.

The inventors tested combinatorial pooling and the minimal discrepancy decoder according to one embodiment of the present invention on a human shRNA library comprising 12,500 different fragments in 40,320 bacterial clones. The inventors optimized the sequencing procedure to yield higher coverage (67 million reads total) and used longer barcodes of 10 nt. Consistency checks on barcode representation revealed substantial background contamination in the combinatorial pools. Decoding the library with the minimal discrepancy decoder according to one embodiment of the present invention revealed an enhancement in the quality score distribution with a peak around value of 25, shown in FIG. 16C. The inventors filtered specimens with quality scores below 5, and retained 36,000 out of the 40,320 clones. To evaluate decoding accuracy, the inventors compared the assignments to conventional sequencing of 384 clones. In this case, the correct decoding rate was 98.2%. When the inventors eliminated quality filtering, the inventors had correct decoding rates of 97.3% for the 40,320 specimens. These results confirm that the quality scores are robust and have predictive value in identifying correct clones.

According to one embodiment of the present invention, a multiplexing framework that encodes the identity of specimens within a pattern that is established by a pooling procedure. The inventors show that both the number of barcodes required and the experimental overhead of pool production to levels acceptable for the analysis of many tens of thousands of specimens are reduced. Both the pooling and decoding methods can be tuned to address different specimen scenarios, different robotic pooling platforms, and different NGSTs. The inventors have investigated the trade-offs in pooling strategies, and validated the procedure both via in silico simulation and through two real case studies. The inventors have discovered that the procedure is largely insensitive to the types of sequencing errors that plague NGST instruments but is vulnerable to low sequencing depth and biochemical failures in template preparation. According to one embodiment, an improved algorithm is provided to address those issues and achieved high decoding rates of greater than 97% on average for all the clones, and robust quality score measurements that enable evaluation of the veracity of state assignments.

The present invention raises the possibility of a new approach to the use of next generation sequencers for personal genomics and population genetics. By analogy to the goal of the $1,000 genome, it would be highly beneficial to reduce the cost of sequencing defined subsets of genes that are responsible for severe genetic diseases or for determining histocompatiblity. The present method is applicable to both of those examples, since in severe genetic diseases one of the alleles (state) is generally very rare and the HLA locus is highly polymorphic. However, these tasks present additional challenges, including inferring the state of a diploid genome and the difficulty of reconstructing complex haplotypes from short reads.

In additional embodiments of the present invention effective read lengths the bulk output of NGSTs are increased. Increasing these variables will allow finding common genetic variations among large number of individuals. While common genetic variations are not easily decodable, extended sequencing lengths will provide additional ‘hitchhiker’ variations, which in total will provide enough polymorphism to detect the state of common variants in individual specimens. Recent studies have shown that autosomal heterozygosity is about 1/1000 nt, implying that 5000-10,000 nt fragments should give enough polymorphism to detect common genetic variations in large samples using the presently presented inventive method.

According to an additional embodiment of the present invention, the inventors suggest a rapid and inexpensive strategy to map causative mutations of tens of diseases in a single experiment. The inventive method synergizes whole exome sequencing with combinatorial pooling.

The previous method for locating and determining a causative mutation of genetic disease required the use of samples from larger families containing members both affected and unaffected by the disease. Each individual sample was required to be sequenced for comparison to other samples in the group, which is very costly and time intensive. Utilizing the present inventive method, however, alleviates the need for a large sample size and can identify a source and location of a causative genetic mutation using only one or two samples from affected individuals.

For example, several dozens of specimens, drawn from individuals affected by a variety of genetic diseases, are pooled according to a combinatorial pattern into significantly smaller number of pools. The combinatorial pattern may be any pattern described in the present disclosure. The pools, instead of individual specimens, undergo exon-capturing and sequencing, circumventing the cumbersome process of preparing large numbers of libraries. After detecting the variations in each pool, the inventive combinatorial pattern and solution methods described in the present disclosure are used to associate each variation with a specimen. The location of causative mutations is determined as in regular whole exome sequencing, but with the advantage of resolving many diseases at once.

As will be understood, additional filtering of the sample results may be performed to aid in association of causative mutations with a sample. For example, each sample may be compared to a known reference sequence, which is used to remove samples that conform to the reference. Further filtering may be applied by comparing the exon sequence with known database entries of exon variations, removing samples that represent previously known variants. As well, filtering may be applied to determine whether the variation is present in a location coding for an amino acid, and removing samples in which the variation is non-protein coding. Additionally, filtering may be applied to determine whether the sample originated from a homozygous sample or heterozygous sample.

As will be understood by one of skill in the art, this method is not restricted to whole exome sequencing, but to any part or the whole genome. As will be understood, any number of amplification and sequencing techniques may be used with the present invention, including, a target enrichment method, solution or solid-phase hybrid selection, multiplexed PCR, padlock amplification, multiplexed rolling circle amplification, or other methods to target a plurality of genomic regions as a back-end to multiplexing, where multiplexing can be with or without specimen barcoding and combinatorial pooling.

Comparing Combinatorial Pooling to Eppstein's Pooling Method

Eppstein's pooling method construction was based on the python backtracking algorithm. One embodiment of the presently presented method is based on C program that performs exhaustive search of co-prime numbers such that their sum is minimal and they are above a certain threshold. Running both programs took up to several seconds on a regular desktop computer.

Simulation of Decoding Performance for the shRNA Library

W=3, 4, 5, and 6 correspond to the following pooling windows: (384,383,381), (384,383,381,379), (384,383,381,379,373), (384,383,381,379,371). BC=200, 300, and 384 correspond to the following barcode combinations: (209, 205, 203, 202, 201), (307, 305, 303, 302, 299), (384, 383, 381, 379, 373). The inventors simulated each pooling design for 1000 random specimen arrays on CSHL's High Performance Computing Cluster (HPCC). The experiment used an IBM E1350 blade-based cluster running Linux. It comprised 500 compute nodes, but the simulation used 100 nodes. Each compute node contained 2 dual-core Opteron 64 processors running at 2.0 GHz, a local 73 GB SFF SCSI disk, and memory from 2 to 8 GB.

Simulation of Decoding Performance for Cystic Fibrosis-Associated Mutations

The error profile of Illumina GAII using Phi-X data was constructed using three runs with Illumina standard base-calling versions>1.0. The sequence reads were aligned to the Phi-X reference genome (NC_{—}001422.1) using BLAT with tolerance of up to 5 mismatches. The error profiles were calculated by enumerating the differences between the reference and the observed sequence read for each cycle. Ns were discarded. This procedure provided 36 4×4 confusion matrices. Each row was normalized to 1 to obtain probabilities. The error profile based on human data was set to 0.05% for all possible substitutions in the first 12 cycles according to the data in Druley et al. (2009).

The aforementioned noise profiles were added to the following sequences: delta508-ATCATCTTTGGTGTTTCCTATGATGAA (WT), ATCATTGGTGTTTCCTATGATGAATAT (M). G1282X: TGGAGGAAAGCCTTTG(WT), TGAAGGAAAGCCTTTG(M).

The pooling design used the following windows: 383 382 381 379 377 373 371.

Arabidopsis Chip Construction

A plasmid library representing 17,553 Arabidopsis synthetic miRNAs based on the miR-319a precursor were synthesized on an Agilent microarray. The DNA eluted and cloned to into a pGreen derivative (unpublished).

GIPZ Chip Construction

A plasmid library representing 12,784 Arabidopsis synthetic shRNAs based on the miR-30 precursor were synthesized on an Agilent microarray. The DNA eluted and cloned to into a GIPZ derivative (Open Biosystems).

Pooling Bacterial Clones

Plasmid DNA was transformed into DH10B E. coli suspension and transformants were selected on a series of Q-tray 20×20 cm petri dishes with LB+spectinomycin at 25 ug/ml medium. 40,320 bacterial colons were arrayed into 105 384-well SBS microplates (Genetix, Catalog number: x7007) using a Genetix QPix colony picker. A Tecan Genesis liquid handling robot carried the pooling using 8 fixed tips. 3 ul of bacterial suspension was taken from each source well and delivered to the each destination well. This was followed by washing the tips by aspirating 30 ul of 70% ethanol from two different ethanol baths and rinsing with milli-Q water. For destination plates the inventors used 5 384-deep well plates (Nunc, Catalog Number: 269390). The pooling procedures were carried out at room temperature.

The pooling design for Arabidopsis was 384, 383, 381, 379, 373. A calculation error caused the inventors to use a window size of 381, which is not co-prime with 384. However, the inventors discovered that this would have an impact only if the number of specimens was above 48768 (least common multiple of 384 and 381).

The pooling design for the human library was 384, 383, 379, 377, 373. In addition, the inventors treated the clones as the first one is #9887, second is #9888 and so on. The reason behind that was to avoid a situation were the same specimen encountered the same barcode in all pooling windows. For instance, in the ordinary design specimens #1 pooled to the first well of each pooling plate, and marked with the barcode #1. In case of a failure in the synthesis process of this barcode, specimen #1 will be lost. When labeling the specimens with larger numbers (e.g. starting with 9887) they encounter different barcodes in the pools and the risk is averaged.

Barcoding and Sequencing—Arabidopsis

5 ul of diluted bacterial culture was taken from each destination well for the PCR amplification. The PCR conditions were: 2 ul of 10×KOD buffer, 0.8 ul of 25 mM MgSO₄, 6 ul of bacterial DNA, 750 nM of each primer, 2 ul of 2 mM dNTPs, 0.4 ul of KOD hot start polymerase; in total 20 ul. The reactions were cycled as follows: 95 C—5 min (hot start), (95 C—35 s/57 C—35 s/68 C—20 s) 22 cycles. The inventors used 384 primer set for each destination plate. The primers were synthesized by Operon, and purchased in 4 96 well deep plates wet (50 uM×200 ul). The reverse primers had the following structure:

5′-CAAGCAGAAGACGGCATACGAGATCGGTCTCGGCATTCCTGCTGAACCGCTCTTCC AT CT********GCGACTCGGTATTTGGATGAATGAGTCG-3′, where the stars indicate 8 nt barcodes that were constructed using a subset of Hamady et al. (2008) barcode set. This subset was constructed by lexicographically sorting the set and choosing every fourth entry. The forward primer was:

5′-AATGATACGGCGACCACCGAGATCTACACCTCGGACGCATATTACA
CATGTTCATACAC-3′.

5 ul of each amplified product was taken, and products of the same pooling group were unified. The inventors gel purified each pooling group of approximately 250 bp. Each one of the pooling groups was sequenced on a distinct lane of Illumina GAII using the standard paired-end protocol of 36 cycles. Pooling window 384 was sequenced additional time as in the first time the number of reads was 300,000. The inventors merged the two runs.

Barcoding and Sequencing—Human GIPZ Library

The inventors used a similar approach to the one indicated in the Arabidopsis set. PCR primers:

Forward:5′-ATCGTTGCCTGCACATCTTGGAAAC-3′.Reverse:

CGGTCTCGGCATTCCTGCTGAACCGCTCTTCCGATCT**********ACATCTG TGGCTTCACTA, where the stars indicates 10 nt barcodes with 5 nt Hamming distance (unpublished).

Decoding

According to one embodiment of the present invention, prototype programs of the decoding procedures were written in Perl and used a mySQL database. The pattern consistency decoder typically took 5-10 min on a desktop computer (CPU: QX6850, 3 Gb RAM, Linux Ubuntu). However, the minimal discrepancy decoder was very demanding and took ˜20 hours on average.

In order to benchmark the decoding results of the Arabidopsis library, the inventors capillary sequenced the specimens of the 1^{st}, 11^{th}, . . . plates, up to the 91^{st} plate. Then, the inventors filtered sequences that did not contain the sequences flanked HindIII and EcoRI restriction sites. In total the inventors left with sequences from 2760 specimens.

More than 4 nt mismatches between the results of the decoder to the capillary sequences were considered as decoding errors and 4 nt and fewer mismatches were considered as sequencing errors on one (or both) of the sequencers. Only 4% of the correct decoding result had sequencing errors. The inventors probed the cause of the sequencing errors by comparing the decoder sequences and the capillary sequences to the reference design. Remarkably, the inventors discovered that in 70% of cases, the sequence reported by the decoder appeared in reference design and in only 25% of the cases was the capillary sequence in the design reference. This indicates that most of the sequencing errors stem from the capillary sequencer and not from the decoder.

For benchmarking the decoding results of the human library, the inventors sequenced an entire 384 plate using a capillary platform (Agencourt) and filtered reads that did not match to the constant loop region of the shRNA design.

Pooling Matrices with Minimal Weight are T˜Ω(\sqrt{N})

As one example, define the decoding robustness as a matrix property called d-disjunct. Then, find the minimal weight of a d-disjunction matrix, and show that it asserts maximal intersection λₘₐₓ=1. This will leads to the number of pools should be higher than \sqrt{N}, when using the minimal weight. Throughout the proof the inventors will follow some of the results of Kautz and Singleton.

Consider a T×N binary matrix M with constant weight w (w>0), and a maximal dot-product λₘₐₓ between the column vectors.

Definition 1: M may be called d-disjunct if and only if the Boolean sum of up to d column vectors of the matrix does not include any other column vector than those used to form the sum. d-disjunction confers that any d specimens with the same state can be uniquely decoded, and that there is a tractable decoding algorithm.

Definition 2: M may be called reasonable if it does not contain a row with only a single T entry. Clearly, if a design includes pools of single specimens, it is more cost effective to genotype those specimens without pooling. Thus, we are only interested in reasonable designs.

Lemma 1: The minimal weight of a reasonable d-disjunct matrix is: w=d+1

Proof: assume w<d+1, and pick any C(i) column vector. According to definition 2, every ‘1’ entry in C(i) intersects with at least one column vector. Thus, there are at most w column vectors that intersect with C(i). The Boolean sum of those w column vectors includes C(i) and the matrix is not w-disjunct. According to definition 1, it can not be d-disjunct, and w>d+1. The existence d-disjunct matrices with w=d+1 was proved by Kautz and Singleton.

Definition 3: M is called minimal-weight d-disjunct in case w=d+1.

Lemma 2: If M is a minimal-weight d-disjunct then λₘₐₓ=1.

Proof: Assume λₘₐₓ occurs between the C(i) and C(j). According to definition 2, the Boolean sum that includes C(i) is composed by at most w−λₘₐₓ+1 column vectors. However, the Boolean sum of any W−1 column vectors does not include C(i). Thus, λₘₐₓ<2, and according to definition 2, λₘₐₓ>0. Thus, λₘₐₓ=1.

Lemma 3: The number of columns of M is bounded by:

$$N \leq \frac{( \begin{matrix}T \\ λ + 1\end{matrix} )}{( \begin{matrix}W \\ λ + 1\end{matrix} )}$$

Proof: See Kautz and Singleton.

Theorem: For any minimal-weight d-disjunct matrix the number of rows is T˜Ω(\sqrt{N})

Proof: plug lemma 2 to lemma 3:

$$N \leq \frac{( \begin{matrix}T \\ 2\end{matrix} )}{( \begin{matrix}W \\ 2\end{matrix} )} = \frac{T ( T - 1 )}{W ( W - 1 )} < \frac{{T}^{2}}{W ( W - 1 )} \text{=} \text{>} \sqrt{W ( W - 1 ) N < T}$$

Then: T˜Ω(\sqrt{N})

On the other hand, conjecture that any d-disjunct matrix with T˜O(ln N) has a weight of at least: W>d(ln N), which is bigger by a ˜ln N factor from the minimal weight.

Mathematical Formulation of the Decoding Procedure

Pattern Consistency Decoder:

Let \hat{χ} be the decoding results with 0/1 entries. In case of binary states \hat{χ} is a vector of N entries (1-Mutant), and an S×N matrix in the multi-state case where S is the number of states. The pattern consistency decoding is given by the following logical condition:

\hat{x}=∂(YM) (11)

where Y is binary S×T matrix, and 1′ in the (i,j) entry denotes that the i-th state found in j-th pool and vice-versa for 0′; ∂: [symbol] ^{S×N}→ [symbol] ^{S×N} is an indicator function that returns 1′ for the (i,j) entry if this entry equals to w and 0 otherwise. The matrix multiplication between Y and M gives the number of constraints each specimen satisfied. The decoder reports only columns of x that contain exactly one 1′ entry. If there is more than one 1′ entry, then the column is reported as ambiguous, and if it is an all-zeros column, it is reported as empty.

We can relax the consistency requirement to tolerate technical failures by:

\hat{x}=(YM>1) (12)

Where l:0<l≦w, but with the price of reduced ability to deal with larger d₀, and losing specificity.

Minimal Discrepancy Decoder:

Let rᵢⱼ be the number of reads of the i-th state in the j-th pool,

$${\overline{r}}_{j} = {\sum }_{i}^{ } {r}_{ij}$$

be the total number of reads in the j-th pool, and yᵢⱼ denotes the discrepancy of the j-th pool regarding the i-th state:

$${γ}_{ij} = - log ( \frac{{r}_{ij}}{\overline{{r}_{j}}} ) \qquad ( 13 )$$

In order to tolerate zero reads of a state in a given pool, define the discrepancy of this case as

$${γ}_{ij} = - log ( \frac{1}{arj} )$$

where a>1 is a tunable parameter. Using an outlier detector, the decoder finds pools with extremely low number of reads (relatively to the other pools in the lane) and treats them as technical failures with

$${γ}_{ij} = - log ( \frac{1}{β * c} ) ,$$

where β>1 is a tunable parameter and c is the size of the corresponding pooling window. Testing few numbers of α, β the inventors found that a≈20 and β≈5 has a moderate positive impact on the results, but further study is needed to analyze their effect.

Combining the discrepancies to form the assignment of each specimen is given by:

\hat{x}=(YM) (14)

Since this procedure requires tedious matrix multiplication, the inventors calculated only entries that correspond to specimens that, during the relaxed pattern consistency algorithm, violates only up to two constraints: \hat{x}=(YM)>2).

According to one embodiment of the present invention, in order to penalize assignments that match large number of specimens in the minimal discrepancy decoder, the inventors created a simple heuristic based on data from the relaxed pattern consistency decoder. For each state/specimen in the minimal discrepancy decoder, identify the corresponding entry in YM matrix of the relaxed pattern consistency decoder, and enumerate the number of entries with the same level along the row. The logarithm of this number is added to the state/specimen of the minimal discrepancy decoder.

At the final step of the minimal discrepancy decoding, find the minimal entry for each column and report its corresponding state. The quality value is calculated by taking the difference between the second minimal entry and the minimal entry.

Compressed Genotyping

Notations

Matrices are denoted as an upper-case bold letter and the (i, j) element of the matrix X as Xᵢⱼ. The shorthand X̅ denotes a matrix that its row vectors are normalized and to sum to 1. I (X) is an indicator function that returns a matrix in the same size as X with:

$$I ( {X}_{ij} ) = \{ \begin{matrix}1 & {X}_{ij} > 0 \\ 0 & {X}_{ij} = 0\end{matrix}$$

The operation |•| denotes the cardinality of a set or the length of a vector. For graphs, ∂α refers to the subset of nodes that are connected to the node α, and the notation ∂α\b means the subset of nodes that are connected to α except of node b. We use natural logarithms.

Genotyping as Bipartite Graph Reconstruction

Consider a single human specimen that is being genotyped for a gene that has two alleles, labeled by A and α. The genotype of this specimen is represented by a vector of length two with three possible outcomes: (2, 0) if the specimen is homozygous for the A allele, (1, 1) if the specimen is heterozygous, and (0, 2) if the specimen is homozygous for the α allele. This representation can also accommodate situations where the gene has more than two alleles in the population, by increasing the length of the vector to the number of the alleles. The genotype of n individuals is represented by an n×s matrix G, called the genotype matrix, that is composed of the genotype vectors as its rows; Gᵢⱼ denotes how many copies of the j-allele the i-individual holds.

Let G be a bipartite multigraph G=(X, S, E, p) that is built according to the genotype matrix, where X is a set of n specimens, S is a set of s possible alleles in the population, and the edge set, E, denotes which subset of alleles each specimen holds. The degree of the specimen nodes, deg(xᵢ), is a constant denoted by p, which represents the genome ploidy and in human p=2. (This assumption is valid for the vast majority of the genotyping problems, but some particular cases that involve copy number variation, such as Spinal Muscular Atrophy (SMA), do not exhibit constant degree for specimen nodes, and they will remain outside the scope of this invention. In addition, for the sex chromosomes in male the degree is one.) The degree of each allele node, deg(sᵢ), is a random variable that is dictated by the prevalence of the genotypes in the population. According to that representation, genotyping is in general the task of reconstructing the bipartite graph from the sequencing information—finding the edge set E where X and S are known, subject to p=2.

In a carrier screen, one is mainly interested in reconstructing a part of the graph, Eᵣᵢₛₖ, that represents the subset of individuals that are carriers of the recessive risk alleles. The graph is very sparse due to the low prevalence of the risk alleles. Moreover, a large portion of severe genetic disease exhibits complete penetrance, meaning that the affected individuals are symptomatic, and therefore are known, and do not participate in the screen. Thus, finding that one edge of a given individual is connected to a risk allele node immediately implies that the other edge is connected to a non-risk allele node, which further reduces the degrees of freedom in the graph reconstruction.

Consider two examples of carrier screens. First, consider a screen for ΔF508, the most prevalent mutation in Cystic Fibrosis (CF) among people of European descent (FIG. 17).

In that case, the set S has two members: WT and mutant, and the expectation of the ratio between deg(sₘᵤₜₐₙₜ) to deg(s_{WT}) is around 1:29 for screens in European. Most specimen nodes send double edges to the WT node, which implies that these specimens carry two copies of the normal allele. A small portion of specimen nodes are connected to the two different allele nodes, meaning that these specimens are carriers for CF. There are no specimens that are connected by double edges to the mutant allele, since this mutation always leads to CF, and the affected individuals do not participate in the screen. Consider also a screen with multiple risk alleles, as in the case of FMR1 gene that causes Fragile X mental retardation. This gene has dozens of alleles, but only a small subset causes the disease. Therefore, one need only to resolve edges to the risk alleles. However, we are interested in more than a binary classification of the specimens to carriers and normals, as the causative alleles carry different degrees of disease risk (technically known as penetrance), and identifying the exact allele vector has clinical utility.

Defining a Cost-Effective Reconstruction

Following the analysis above, a genotyping assay is a query of the form: which allele nodes are connected to the interrogated specimen nodes? The current DNA sequencing methods that rely on serial specimen processing perform this query for each individual separately. However, the sparsity and the restricted structure of G suggest that Eᵣᵢₛₖ may be found in a relatively small number of queries when performing the queries on pools of specimens. Fortunately, the sequencing capacity of next generation sequencers enables the querying of pools of large numbers of specimens.

The task of reconstructing G in the most cost effective way is referred to as the minimal genotyping problem. Note that this task is intentionally not defined as minimizing the number of queries, since there are additional factors that determine the cost and the feasibility of the procedure.

The present invention provides a minimal genotyping strategy that is based on a non-adaptive query schedule, in order minimize the turnover time and the need to re-pool the specimens multiple times. The strategy starts by pooling samples of the specimens according to a certain design as denoted by Φ, which is a t×n binary matrix; the columns of Φ represent specimens, and each row determines a pool of specimens to be queried. For example, if the first row of Φ is (1, 0, 1, 0, 1 . . . ), it specifies that the 1^{st}, 3^{rd}, 5^{th} specimens are pooled and queried (sequenced) together. Since the pooling is carried out using a liquid handling robot that can take several specimens in every batch, the inventors only consider designs in which all specimens are sampled the same number of times to reduce the robotic logistics. The weight w of Φ is the number of times a specimen is sampled, or the number of 1 entries in a given column vector: every column is constrained to have the same number of l's in this design. Let rᵢ be the compression level of the iₜₕ query, namely the number of 1 entries in the i^{th} row, which denotes the number of specimens in the i^{th} pool.

In large scale carrier screens, n is typically between few thousands to tens of thousands of specimens. The query is restricted to designs with rₘₐₓ≦1000 specimens, due to technical and biological limitations (in DNA extraction and PCR amplification) when processing pools with larger number of specimens. Notably, a single query in these designs, even when composed of 1000 specimens, does not saturate the sequencing capacity of next generation platforms the sequencing capacity of next generation platforms. In order to fully exploit the capacity, queries are pooled together into query groups until the size of each group reaches the sequencing capacity limit, and those groups are sequenced in distinct reactions. Before pooling the queries, each query is labeled with a unique DNA barcode in order to retain its identity. Thus, the number of queries, t, is proportional to the number of DNA barcodes that should be synthesized. One objective of the query design, similar to those found in group testing and compressed sensing, is to minimize t.

In practice, once the DNA barcodes are synthesized, there is enough material for a few dozen experiments. One can re-use the same barcode reagents for every query group as these are sequenced in distinct reactions. Hence, the number of queries in the largest pooling group, Tₘₐₓ, dictates the synthesis cost for a small series of experiments. While this does not change the asymptotic cost (e.g. for synthesizing barcodes for a large series of experiments), it has some practical implications.

The overall sequencing capacity needed for genotyping is proportional to Σᵢ₌₁^{t}rᵢ, the number of queries and their size. Since by construction nw=Σᵢ₌₁^{t}rᵢ, the weight w determines the requisite sequencing capacity for a given number of specimens, and it is an additional factor that should be minimized in order to achieve a cost effective design. Moreover, decreasing the weight also reduces the number of times a specimen is sampled, and consequently, the robot time, and the amount of material that is consumed.

Next-generation sequencers are usually composed of several distinct biochemical chambers, called ‘lanes’, that can be processed in a single batch. The inventors assume that the sequencing capacity needed for n specimens corresponds to one lane. Recent data has shown that when the number of specimens is a few thousand up to tens of thousands this assumption is valid. Since in total nw aliquots of specimens are sampled in the pooling step, one needs w lanes to sequence the entire design, where each lane is loaded with a different query group.

The inventors do not intend to specify a global cost function that includes the costs of barcode synthesis, robotic time, sequencing lanes, and other reagents. Clearly, these costs vary with different genotyping strategies, sequencing technologies, and so on. Rather, the inventors present heuristic rules that would be applicable in most situations. First, w should not exceed the maximal number of lanes that can be processed in a single sequencing batch, as launching a run is expensive and time consuming, and currently, for the most widespread next generation sequencing platform, w≦8. Therefore, it is also desirable that a design construction will have an explicit mechanism to specify the target weight. Second, the inventors assume that the cost of adding a sequencing lane is about two to three orders more than the cost of synthesizing an additional barcode. This will mainly served to benchmark the results of our design to the outcome of other designs that were studied in group testing. Table 2 presents the notations the inventors used.

TABLE 2
Summary of Query Design Parameters

| Notation | Meaning | Typical Values | Comments |
|---|---|---|---|
| Φ | Query design | | |
| n | No. of specimens | Thousands | |
| t | No. of queries | | Total number of barcodes |
| w | Weight | ≦8 | Denotes the lanes and |
| | | | corresponds to the |
| | | | robotics efforts |
| rₘₐₓ | Max. level of | ≲1000 | Number of times a |
| | compression | | specimen is sampled |
| Tₘₐₓ | Max no. of | Up to a few | Barcode synthesis |
| | queries in one of | hundreds | reactions for a |
| | the query groups | | single experiment |

The query design for the minimal genotyping problem is to find a t×n design matrix composed of 0's and 1's Φ that provides sufficient information to reconstruct G, while minimizing t and keeping the column sum or weight w below a certain threshold. A design that addresses these objectives is termed a light weight design.

The Compositional Channel

The sequencing procedure starts by capturing random DNA molecules from the input material, and therefore, the ratios of sequence types reflect the corresponding ratios of the genotypes in the input material. For example, consider a sample that is composed of a mixture of two specimens in equal ratio, where one specimen is homozygous WT and the other is heterozygous. The outcome of a successful sequencing batch will consist of 3/4 sequence reads from the WT allele, and 1/4 from the mutant genotype. Since the input material in the present example is composed of pools of specimens, the sequencing results are given by to following conditional probability:

f_{β}(Y|ΦG) (15)

where Y is a t×s matrix that denotes the sequencing results, namely the number of sequence reads for each genotype/query combination, and G is the n×s bi-adjacency matrix of the genotyping graph. β is a sampling parameter, a non-negative integer that denotes the number of reads for each query. In reality, β is a random variable with Poisson distribution, since each query has different number of reads. However, for simplicity we will treat it as a constant. f_{β}(Y|X) denotes a multinomial random process that corresponds to the sampling procedure of the sequencers, the joint distribution of the sequencing results is therefore given by:

$${f}_{β} ( Y \vert X ) = {\prod }_{i = 1}^{t} {α}_{i} exp ( - β {\sum }_{j = 1}^{a} \overline{{Y}_{ij}} log ( 1 / \overline{{X}_{ij}} ) ) \\ where α i = \frac{β !}{{\prod }_{j = 1}^{s} {Y}_{ij} !} \qquad ( 16 )$$

As β→∞ the relative ratios of a row in Y become similar to the ratios of allele nodes degrees of the subgraph induced by the specimens in the pool. We will term f_{β}(^{•}) compositional channel with parameter β. This name is used because the channel places s-dimensional real space input vectors in an s−1-dimensional simplex, which is reminiscent of the concept of compositions in data analysis.

The compositional channel is closely related to two other channels, the superimposed channel, and the linear channel. As mentioned earlier, the superimposed channel has been extensively studied in the group testing literature, and describes queries that only return the presence or absence of the tested feature among the members in the pool. On pooled data, measured without noise, the superimposed channel would be given by:

Yₛ=Π(ΦG) (17)

The information degradation here is more severe than in the case of the compositional channel, since the observer can not quantify the number of positive items from a single query with a positive answer. The output of the compositional channel can be further processed as if it was obtained by a superimposed channel. In that case Yₛ denotes only the presence/absence of an allele in a query. This degradation is given by:

Yₛ=Π(Y) (18)

The linear channel describes the result of a query as a linear combination of the samples in the pool, and is given by:

Yᵢ=ΦG (19)

This type of channel serves as the main model for compressed sensing, and it captures many physical phenomena. Closely related models were studied in group testing for finding counterfeit coins with a precise spring scale and for T-user adder channels. Ideally, when one knows the number of specimens in each pool, and β→∞, data from the compositional channel can be treated as if it was obtained by a linear channel, since the compositional vectors can be placed back in the real space by normalizing Y to → Y̅ and multiplying the result with the number of specimens in each query.

In addition to the sampling process, the sequencer may also produce errors when reading the DNA fragments. Since the fragments are composed of a barcode region and the interrogated region, sequencing errors may lead to association of sequence reads with the wrong query, and to an incorrect genotype detection. DNA barcodes can be easily extended in order to add more redundancy to the codeword that they carry. Experience has demonstrated that that errors in barcode annotation are insignificant, and the inventors will not treat this type of errors.

On the other hand, sequencing errors in the interrogated region are more involved and the inventors will classify them into two categories according to their outcome: confounding errors, meaning that a sequence read that was derived from one genotype is decoded as another valid genotype, or non-sense errors, meaning that a decoded sequence read does not correspond to any allele node in G. Nonsense errors are easily handled, for instance, by filtering those sequence reads, as we assume that all possible alleles are known beforehand. Unfortunately, there is no simple remedy for confounding errors, and they may distort the observed allele ratios in the queries. For instance, consider a pool of 100 specimens none of which has a mutant allele that is sampled with β→∞. If the confounding error rate is 0.5%, the data will falsely indicate that one of the specimens in the pool is a carrier. The effect of the sequencing errors on genotyping may be denoted by a conditional probability which includes a confusion matrix:

f_{β}(Y|ΦGΛ) (20)

Λ denotes an s×(s+1) confusion matrix that indicates the probability that the i^{th} genotype is confounded with the j^{th} genotype; the s+1 column indicates the transition probability to a non-sense genotype. The process in Eq. (20) is referred to as compositional channel with errors.

The values of Λ are dependent on the sequence differences between the interrogated alleles and on the specific chemistry that is utilized by the sequencing platform. Based on previous work regarding the most abundant next generation sequencer, we presume that subtle mutation differences (known as SNPs), such as W1282X mutation in CF or Y231X mutation in Canavan disease, correspond to confounding error rates of up to 1%. When the sequence differences are more profound, like in ΔF508 mutation in CF, it is expected that the s×s left submatrix in Λ will resemble the identity matrix. Table 3 summarizes the different channel models described herein.

TABLE 3
Comparison of Different Channels Models

| Channel model | Measurement process | Example |
|---|---|---|
| Superimposition | OR operation | Antibody reactivity |
| Compositional | Multinomial sampling | New generation sequencing |
| Linear | Additive | Spring scale |

Query Design

Constraints on Light-Weight Designs

Group testing theory suggests a sufficient condition for Φ, called d-disjunction, that ensures faithful and tractable reconstruction of any up to d sparse vector that was obtained from a superimposed channel. Since the compositional channel can be degraded to a superimposed channel, d-disjunction is also a sufficient criterion for reconstructing a d sparse vector over a noise free compositional channel. Respecting a carrier screen and reconstruction Eᵣᵢₛₖ, if each risk allele node has less than d edges, d-disjunction is a sufficient condition to reconstruct Eᵣᵢₛₖ. This is of course given a sufficient sequencing depth (β>2rₘₐₓ log(2rₘₐₓ) according to the coupon collector problem) and no errors.

Based on the analysis about cost effective designs, we are looking for non-trivial d-disjunct matrices that reduces the number of barcodes with a minimal increase in the weight.

Definition 1: Φ is called d-disjunct if and only if the Boolean sum of up to d column vectors of the matrix does not include any other column vector than those used to form the sum.

Definition 2: Φ is called reasonable if it does not contain a row with only a single 1 entry, and its weight is more than 0.

We are only interested in reasonable designs. Clearly, if a design includes queries composed of single specimens, it is more cost effective to genotype those specimens in serial processing.

Definition 3: λᵢⱼ is the dot-product of two column vectors of Φ, and λₘₐₓ [symbol] max(λᵢⱼ),

Lemma 4: The minimal weight of a reasonable d-disjunct matrix is: w=d+1.

Proof: Assume that λₘₐₓ occurs between \vec{C(i)} and \vec{C(j)}, two column vectors in Φ. According to definition (2), every 1 entry in \vec{C(i)} intersects with at least one column vector. Thus, there are at most w column vectors that intersect with \vec{C(i)}. The Boolean sum of those w column vectors includes \vec{C(i)}, so the matrix is not w-disjunct. According to definition (1), it can not be d-disjunct, and w=d+1. The existence d-disjunct matrices with w=d+1 was proved by Kautz and Singleton.

Definition 5: Φ is called light-weight d-disjunct in case w=d+1.

Lemma 6: Φ is a light-weight (w−1)-disjunct iff λₘₐₓ=1 and Φ is reasonable.

Proof: First we prove that if Φ is a light-weight w−1-disjunct then λₘₐₓ=1. Assume λₘₐₓ occurs between \vec{C(i)} and \vec{C(j)}. According to definition (2), there is a subset of at most w−λₘₐₓ+1 column vectors that \vec{C(i)} is included in their Boolean sum. However, the Boolean sum of any w−1 column vectors does not include \vec{C(i)}. Thus, λₘₐₓ<2, and according to definition (2), λₘₐₓ>0. Thus, λₘₐₓ=1. In the other direction, Kautz and Singelton proved that d=└(w−1)/λₘₐₓ┘, and Φ is light-weight according to definition (5).

Lemma 7: The number of columns of Φ is bounded by:

$$n \leq \frac{( \begin{matrix}t \\ {λ}_{max} + 1\end{matrix} )}{( \begin{matrix}w \\ {λ}_{max} + 1\end{matrix} )} \qquad ( 21 )$$

Proof: see Kautz and Singelton.

Theorem 8: The minimal number of rows, t, in a light-weight d-disjunct matrix is t>{square root over (((w−1)n)}

Proof: —plug lemma (6) to lemma (7):

$$n \leq \frac{( \begin{matrix}t \\ 2\end{matrix} )}{( \begin{matrix}w \\ 2\end{matrix} )}$$

$$n \leq \frac{{t}^{2}}{w ( w - 1 )}$$

$$\sqrt{w ( w - 1 ) n \leq t}$$

Corollary 9: The minimal number of barcodes is Tₘₐₓ≅\sqrt{n} in a light-weight weight design

Proof: There are w query groups, and the bound is immediately derived from theorem (8).

A light weight design is characterized by λₘₐₓ=1, and t˜Ω((d+1)\sqrt{n}) rows. The low attribute does not only increase the disjunction of the matrix but also eliminates any short cycle of 4 in the factor graph built upon Φ, which enhances the convergence of the reconstruction algorithm.

Light Chinese Design

A light weight design construction based on the Chinese Remainder Theorem (CRT) reduces the number of queries to the vicinity of the lower bound derived in the previous section, and can be tuned to different weights and numbers of specimens. The repetitive structure of the design simplifies its translation to robotic instructions, and permits easy monitoring.

Constructing Φ starts by specifying: (a) the number of specimens, and (b) the required disjunction, which immediately determines the weight. Accordingly, a set of w positive integers Q={q₁, . . . , q_{w}}, called query windows, is chosen with the following requirement:

∀{qᵢ,qⱼ},i≠j:lcm(qᵢ,qⱼ)≧n (22)

where lcm denotes the least common multiplier. Every specimen x is mapped to a residue system (r₁, r₂, . . . , r_{w}) according to:

$$\begin{matrix}x ≡ {r}_{1} & ( mod {q}_{1} )\end{matrix} \\ \begin{matrix}x ≡ {r}_{2} & ( mod {q}_{2} )\end{matrix} \\ ⋮ \\ \begin{matrix}x ≡ {r}_{w} & ( mod {q}_{w} )\end{matrix} \qquad ( 23 )$$

Then, we create a set of w all-zero sub-matrices Φ⁽¹⁾, Φ⁽²⁾, . . . called query groups with sizes qᵢ×n. The submatrices capture the mapping in Eq. (19) by setting Φᵣₓ⁽ⁱ⁾=1 when the clause: x=≡(mod qᵢ) is true. Finally, we vertically concatenate the submatrices to create Φ:

$$Φ = [ \frac{[ {Φ}_{1} ]}{\frac{[ {Φ}_{2} ]}{\frac{⋮}{{Φ}_{w}}}} ] \qquad ( 24 )$$

For instance, this is Φ for n=9, and ω=2, with {q₁=3, q₂=4}:

$$Φ = [ \frac{\begin{matrix}1 & 0 & 0 & 1 & 0 & 0 & 1 & 0 & 0 \\ 0 & 1 & 0 & 0 & 1 & 0 & 0 & 1 & 0 \\ 0 & 0 & 1 & 0 & 0 & 1 & 0 & 0 & 1\end{matrix}}{\begin{matrix}1 & 0 & 0 & 0 & 1 & 0 & 0 & 0 & 1 \\ 0 & 1 & 0 & 0 & 0 & 1 & 0 & 0 & 0 \\ 0 & 0 & 1 & 0 & 0 & 0 & 1 & 0 & 0 \\ 0 & 0 & 0 & 1 & 0 & 0 & 0 & 1 & 0\end{matrix}} ]$$

When x=qᵢ we set rᵢ=qᵢ, so the first row in every submatrix is 1

Definition 10: A construction of Φ according to Eq. (22, 23, 24) is called light Chinese design.

Theorem 11: A light Chinese design is a light weight design.

Proof: Let x≡vₓ (mod qᵢ) and x=uₓ (mod qⱼ), where i≠j. According to the CRT, there is a one-to-one correspondence ∀x:x [symbol] (uₓ, vₓ). Thus, every two positive entries in \vec{Cₓ} are unique. Consequently, |\vec{Cₓ}∩\vec{C}_{Y}<2, and λₘₐₓ<2. Since specimens in the form r, r+qᵢ, r+2*qᵢ are pooled together Φ, λₘₐₓ=1. According to lemma (6) Φ is light-weight.

Comparison to Logarithmic Designs

It is well established in group testing theory and in compressed sensing that certain designs can reach to the vicinity of the lower theoretical bound of t˜O(d log n). The t˜O((d+1)\sqrt{n}) scale in light weight designs raises the question whether they are really the most cost effective solution for the minimal genotyping problem with thousands of specimens and w<8.

The inventors compared the results of the light Chinese design with the method of Eppstein, which shows for the general case the maximal reduction oft. Interestingly, it is also based on the CRT, but without the assertion in Eq. (22). Instead, their method requires that Q will be composed of co-prime numbers whose product is more than nd in order to create a d-disjunct matrix. The number of queries in their method for a given d is:

t˜O(d² log² n/(log d+log log n)) (25)

and the weight is:

w˜O(d log n/(log d+log log n)) (26)

Notice that their weight scales with the number of specimens, implying that more sequencing lanes and robotic logistic are required with the growth of n even if d is constant. The inventors compared the two approaches for screens that includes 5000 specimens and 40000 specimens (Table 4).

TABLE 4
Comparison between Eppstein's Method and the Light Chinese Design

| | | Eppstein | | | | Light Chinese Design | | | |
|---|---|---|---|---|---|---|---|---|---|
| n | d | t | w | Tₘₐₓ | rₘₐₓ | t | w | Tₘₐₓ | rₘₐₓ |
| 5000 | 3 | 149 | 10† | 29 | 1000 | 293 | 4 | 77 | 64 |
| | 4 | 237 | 12† | 37 | 714 | 370 | 5 | 77 | 64 |
| | 5 | 336 | 15† | 47 | 1000 | 449 | 6 | 79 | 64 |
| 40000 | 3 | 209 | 12† | 37 | 8000† | 811 | 4 | 205 | 199 |
| | 4 | 335 | 14† | 47 | 5714† | 1020 | 5 | 209 | 199 |
| | 5 | 472 | 17† | 59 | 5714† | 1231 | 6 | 211 | 199 |

First, the inventors found that Eppstein's method is not applicable to the biological and technical constraints in the genotyping setting of w<8 and rmax≲1000 (labeled in the table with †). Second, the differences between the number of barcodes, τmax and the number of queries in their method are no more than ten fold, but their weights are least 2.5 fold greater than the weights in the light Chinese design. With the estimated cost ratio between barcode to sequencing lane to be around 1:100, the light Chinese design is more cost effective. Finally, there is no intrinsic mechanism in Eppstein's method to specify the weight, and to limit it below a threshold.

Reconstruction Algorithms

Bayesian Decoding Using Belief Propagation

The other part of the minimal genotyping problem is how to reconstruct G given Y and Φ. In general, this is an ill-posed inverse problem, but the sparsity of G due to the biological constraints (e.g. the diploidy of the genome and the absence of affected individuals in the screen) and the low abundance of rare risk alleles permits such decoding. The MAP decoding of the genotyping problem is given by:

$${G}_{MAP} {=}^{Δ} {arg max}_{{x}_{1} , … , xn} Pr ( {x}_{1} , … , {x}_{n} \vert Y ) \qquad ( 27 )$$

For simplicity, assume no prior knowledge of the specimens besides the expected frequency of the genotypes in the screen. Notice that kinship information between the specimens and familial history regarding genetic diseases are known is some cases and may enhance the decoding results, however, they will remain outside the scope of this manuscript. η is a probability vector with length of s(s+1)/2 that denotes the expected prevalence of each genotype. For instance, for ΔF508 screen η=(29/30, 1/30, 0) for normal, carriers, and affected. Let xᵢ be an instance of row vector in G, and c(xᵢ) be a binary vector with length as η that maps the allelic configuration of xᵢ to an entry in a list of genotypes. For instance, if there are two alleles in the population, xᵢ is either (2, 0), (1,1), or (0, 2), and c(xᵢ) is (1, 0, 0), (0, 1, 0), or (0, 0, 1), correspondingly. The prior probability of xᵢ is denoted by:

$$ϕ ( {x}_{i} ) = {\prod }_{j = 1}^{s ( s + 1 ) / 2} {η}_{j}^{{c}_{j} ( {x}_{i} )} \qquad ( 28 )$$

The prior probability for a certain graph configuration, (xᵢ, . . . , xₙ), is:

$${\prod }_{i = 1}^{n} ϕ ( {x}_{i} ) \qquad ( 29 )$$

The data is also a subject to factorization, since the result of a particular query is solely determined by the specimens in the pool:

$$Pr ( Y \vert {x}_{1} , … , {x}_{n} ) = {\prod }_{a = 1}^{t} Pr ( {Y}_{a} \vert {x}_{\partial a} ) \qquad ( 30 )$$

x_{∂α} denotes a configuration of the subset of specimens in the a query, and Yₐ denotes the a^{th} row vector in Y. The probability distribution Pr(Yₐ|x_{∂α}) is given by the compositional channel model in Eq. (20) and since we assume that β and Λ are constant for all the queries, we will use the following shorthand to denote this probability distribution:

Ψ_{α}(x_{∂α}) [symbol] f_{β}(x_{∂α}Λ) (31)

From Eq. (27-31), we get:

$$Pr ( G ) ∝ {\prod }_{a = 1}^{t} {Ψ}_{a} ( {x}_{\partial a} ) {\prod }_{i = 1}^{n} ϕ ( {x}_{i} ) \qquad ( 32 )$$

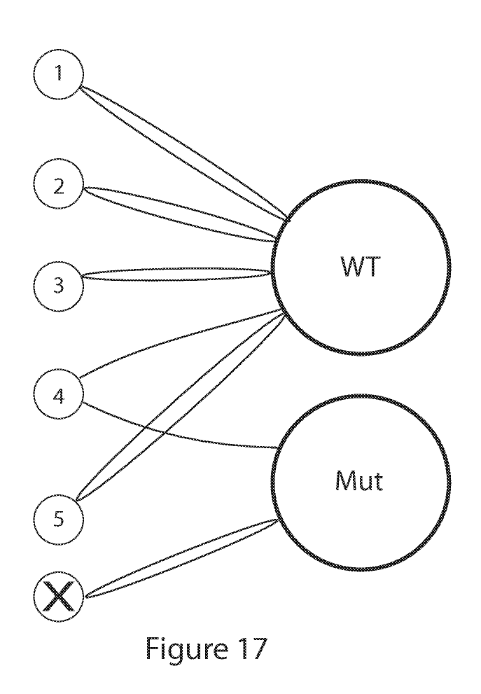

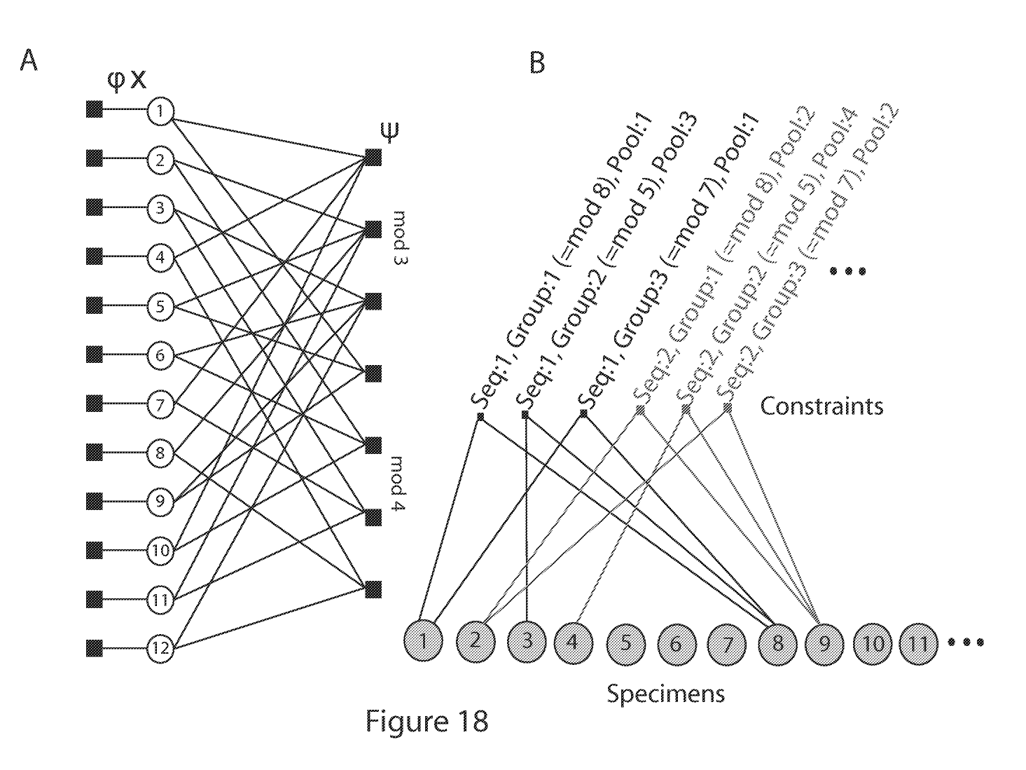

The factorization above is captured by factor graph with two types of factor nodes, φ nodes and Ψ nodes. The φ nodes are uniquely connected to each variable nodes, whereas the Ψ nodes are connected to the variables according to the query design in Φ, so each variable node is connected to w different Ψ nodes. An example of a factor graph with 12 specimens, and Q=3, 4 is given in FIG. 18.

Belief propagation (sum-product algorithm) is a graphical inference technique that is based on exchanging messages (beliefs) between factor nodes and variable nodes that tune the marginals of the variable nodes to the observed data. When a factor graph is a tree, the obtained marginals are exact; however, a factor graph that is built according to any reasonable query design will always contain many loops (easily proved by the pigeonhole principle), implying that finding G_{MAP} is NP-hard. Surprisingly, it has been found that belief propagation can still be used as an approximation method for factor graphs with loops. These findings rely on the concept that if the local topology of a factor graph is a tree-like, the algorithm can still converge with high probability. This approach has been successfully used in a broad spectrum of NP-hard problems including decoding LDPC codes, finding assignments in random k-SAT problems and even solving Sudoku puzzles.

Recently, others have studied the decoding performance of belief propagation in the prototypical problem of group testing. One advantage of this setting is the presence of ‘sure zeros’—variables nodes that are connected to at least one ‘inactive’ test node. Since the tests are faultless in the prototypical problem, those variables are immediately decoded as ‘inactive’, and are stripped off from the factor graph, which reduces the complexity of problem handed to the belief propagation. Unfortunately, the query results from next generation sequencers are not reliable, and the absence of an allele node from a query may stem from insufficient sequencing coverage (small β) and sequencing errors. Furthermore, the total number of sure zeros can be very small as confounding errors may falsely indicate the presence of an allele in a query. From these two reasons, stripping has little applicability in the present setting. On the other hand, Baron and colleagues investigated the performance of belief propagation for the recovery of compressed signals with a linear channel model and additive white Gaussian noise (AWGN). The approach of the present invention employs belief propagation on the full graph using some essential shortcuts.

The marginal probability of xᵢ is given by the Markov property of the factor graph:

$$Pr ( {x}_{i} ) ∝ ϕ ( {x}_{i} ) {\prod }_{a = 1}^{w} {μ}_{a \to {x}_{i}} ( {x}_{i} ) \qquad ( 33 )$$

The approximation made by belief propagation in loopy graphs is that the beliefs of the variables in the subset ∂α\xᵢ regarding xᵢ are independent. Since λₘₐₓ=1 in light-weight designs, the resulted factor graph does not have any short cycles of girth 4, implying that the beliefs does not strongly correlated, and that the assumption is approximately fulfilled. The algorithm defines μα→>xᵢ(xᵢ) as:

$$\begin{matrix}{μ}_{a \to {x}_{i}} ( {x}_{i} ) = {\sum }_{\{ x ∈ \partial a \backslash {x}_{i} \}} {Ψ}_{α} ( {x}_{\partial a} ) {\prod }_{{x}_{j} ∈ \partial a \backslash {x}_{i}} {μ}_{{x}_{j}} & ( 34 ) \\ {μ}_{{x}_{j} \to a} ( {x}_{j} ) = ϕ ( {x}_{j} ) {\prod }_{u ∈ \partial {x}_{j} \backslash a} {μ}_{u \to {x}_{j}} ( {x}_{j} ) & ( 35 )\end{matrix}$$

were uε∂xⱼ denotes the subset of queries with xⱼ. Eq. (34) describes message from a factor node to a variable node, and Eq. (35) describes message from a variable node to a factor node. By iterating between the messages the marginals of the variable nodes are gradually obtained, and in case of successful decoding the algorithm reaches to a stable point, and reports G*:

$${G}^{*} {=}^{Δ} {arg max}_{{x}_{i}} Pr ( {x}_{i} ) \qquad ( 36 )$$

This approach encounters a major obstacle: calculating the factor to node messages requires summing over all possible genotype configurations in the pool, which exponentially grows with the compression level, rₘₐₓ, or \sqrt{n}. To circumvent that, the inventors use Monte-Carlo sampling instead of an exact calculation to find the factor to node messages of each round. This is based on drawing random configurations of x_{∂α} according to the probability density functions (pdf) that are given by the μ_{xi→α}(xⱼ) messages and evaluating Ψₐ(x_{∂α}). An additional complication is strong oscillations in which the marginal estimation of xᵢ for the τ step is almost completely concentrated in one state, but at the τ+1 step, the estimation is completely concentrated in another state. One of those states is obviously wrong, and a sampling process that uses this pdf to evaluate a factor to node message for other variable nodes may find only very small values of Ψ, which is prone to numerical stability issues that ended up in sending all-zero messages and failure of the algorithm. The inventors used message damping to attenuate the oscillations. The damping procedure averages the variable to factor messages of the m round with the message of the m−1 round:

μₓ_{ⱼ}_{→α}^{m(damped)}(xⱼ)=(μₓ_{ⱼ}_{→α}^{m}(xⱼ))^{1-γ}(μₓ_{ⱼ}_{→α}^{m-1}(xⱼ))^{γ} (37)

The extent of the damping can by tuned with γε[0, 1]. When γ=1 there are no updated at all, and when γ=0, we restore the algorithm in Eq. (35). A full layout of the belief propagation reconstruction algorithm is as follows:

1) Inputs: Query design Φ, sequencing results Y, prior expectations about the genotypes prevalence η, damping parameter γ, number of iterations mₘₐₓ, and number of Monte Carlo rounds z.

2) Preprocessing: (a) find β—enumerate the number of reads in the query. (b) learn the genotype error pattern Λ—the sequencing errors rates are estimated using spiked-in controls [30], and converted to genotype error according to the sequence of the different alleles. (c) calculate φ according to η.

3) Initialization: Initialize the iteration counter m. Initialize μₓ_{_{i→α}}(xᵢ) to priors in Φ.

4) Send messages from factors to variables:

1: for each factor a in {1, ..., t} do
2: for each variable xᵢ in query a do
3: for each state of variable xᵢ in {1, ..., |η|} do
4: Set ψ₀ ← 0
5: for {1, ..., z} Monte-Carlo round do
6: r ← random configuration of ∂a\x according to pdfs in μₓ_{_{j→a}}^{m}
7: ψ₀ ← ψ₀ + ψₐ(r, state of xᵢ)
8: end for
9: μ_{a→x} (state of xᵢ) ← ψ₀/m
10: end for
11: Normalize μ_{a→x}_{₁} (xᵢ)
12: Send message μ_{a→x}_{₁} (xᵢ)
13: end for
14: end for

5) Send messages from variables to factors:

1: for each variable xᵢ in {1, ..., η} do
2: for each factor a connected to xᵢ do
3: Set μ_{xi→a}^{m} to all ones vector.
4: for each possible state of variable xᵢ in {1, ..., |η|} do
5: for each factor j connected to xᵢ except a do
6: μₓ_{_{i→a}}^{m} (state of xᵢ) = μₓ_{_{i→a}}^{m} (state of xᵢ)
μ_{j→x}_{ᵢ} (state of xᵢ)
7: end for
8: end for
9: Include prior by μₓ_{_{i→a}}^{m} (xᵢ) ← μₓ_{_{i→a}}^{m} (xᵢ)φ(xᵢ)
10: Damp μₓ_{_{i→a}}^{m} (xᵢ)
11: Normalize μₓ_{_{i→a}}^{m} (xᵢ)
12: Send message μₓ_{_{i→a}}^{m} (xᵢ)
13: end for
14: end for
15: m ← m + 1
Go back to step 4 if m < mₘₐₓ.

6) Marginalize: For every variable node compute the marginal according to Eq. (33), and find the state of the variable with the highest probability.

7) Report: Report the highest state of each variable and construct G.

Baseline Reconstruction Algorithm

In order to benchmark the belief propagation decoding algorithm above, an additional algorithm, named pattern consistency decoding, is introduced. This algorithm is used in group testing to reconstruct the original data from superimposed channel. In a carrier screen, the algorithm first creates a new matrix that is composed of the columns in Y that correspond to the risk alleles, and then it treats the results in the new matrix as superimposed according to Eq. (18). The new matrix is denoted by Yᵣₛ.

This method does not address query errors, and a specimen is defined as a carrier only if all its w queries indicate the presence of a risk allele:

[symbol]

=II(Yₛ^{T}Φ) (38)

where II is an indicator function:

$$𝕀 ( {X}_{ij} ) = \{ \begin{matrix}1 & {X}_{ij} = w \\ 0 & otherwise ,\end{matrix} \qquad ( 39 )$$

Rows of Eᵣᵢₛₖ with positive entries indicate carriers. This reconstruction is guaranteed to be correct if d₀, the maximal number of carriers in the screen for one of the risk alleles, is lower than d, the disjunction property of Φ, (given no sequencing errors and sufficient coverage). Since this reconstruction works with degraded information compared to belief propagation, the inventor use it to indicate the baseline performance expected from belief propagation decoding, and to test whether the approximations we employed (loopy messages, Monte-Carlo sampling, damping) are valid.

Example of Compressed Genotyping

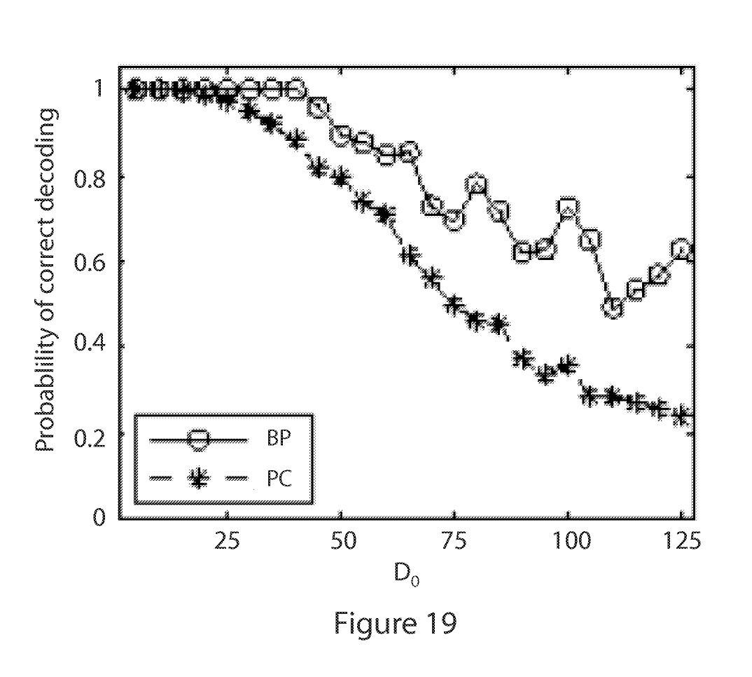

To demonstrate the power of the described method, several settings were simulated where there is one risk allele and one WT allele in the population, with n=1000, β=10³, w=5, and Q={33, 34, 35, 37, 41}, which can be accommodated in a single machine batch. FIG. 19 emphasizes the effect of damping on the belief propagation convergence rates. In this example, the number of carriers in the screen was d₀=43, and the decoder was run for 30 iterations. The inventors evaluated different extents of damping: γε[0.1, . . . , 0.9], and measured for each iteration the averaged absolute difference in the marginal from the previous step. With γ<0.5, there are strong oscillations and the algorithm does not converge, whereas with γ≧0.5, there are no oscillations, and the algorithm converges and correctly decodes the genotype for all the specimens.

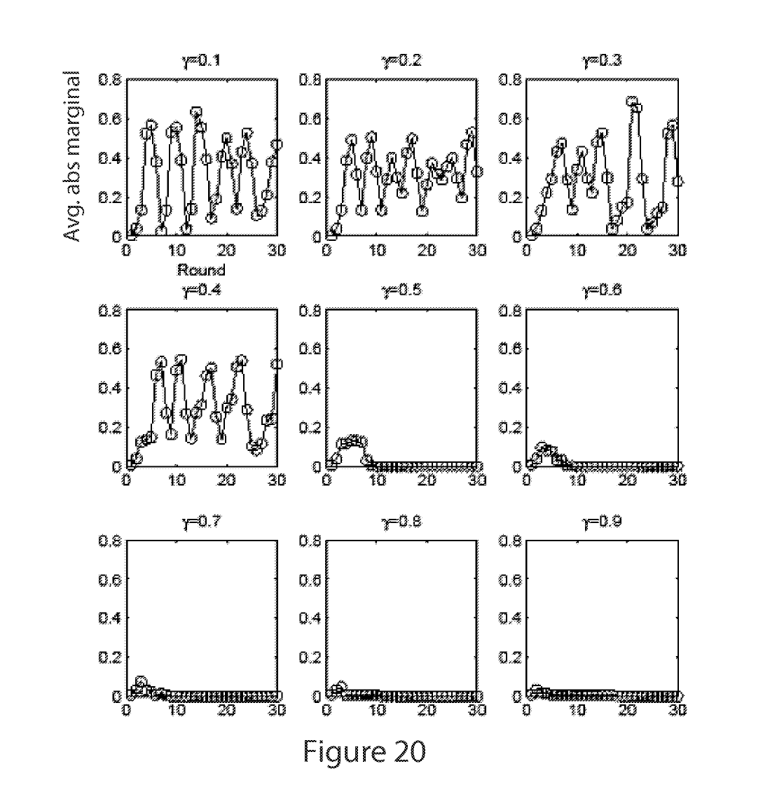

The inventors also tested the performance of the reconstruction algorithms for increasing number of carriers in the screen, ranging from 5 to 150, with no sequencing errors (FIG. 20). The belief propagation reconstruction outperformed the pattern consistency decoder and reconstructed the genotypes with no error even when the number of carriers was 40, which is a quite high number for severe genetic diseases. The ability of the belief propagation to faithfully reconstruct cases with d₀>>d-disjunction of the query design is not surprising, since d-disjunction is a conservative sufficient condition even for a superimposed channel.

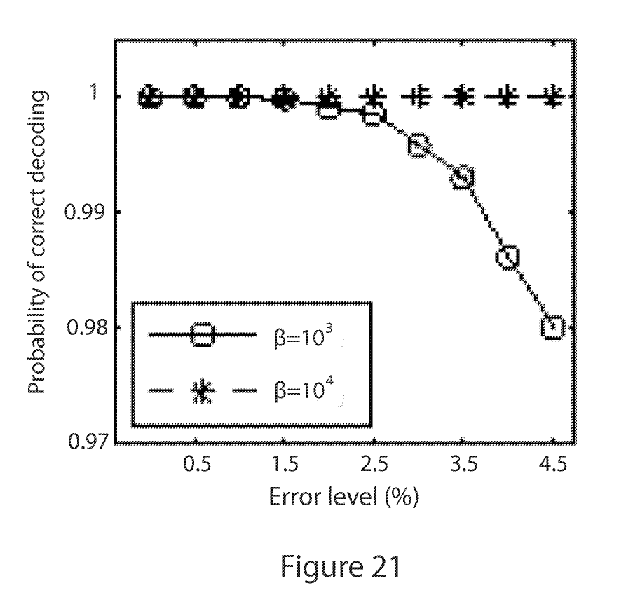

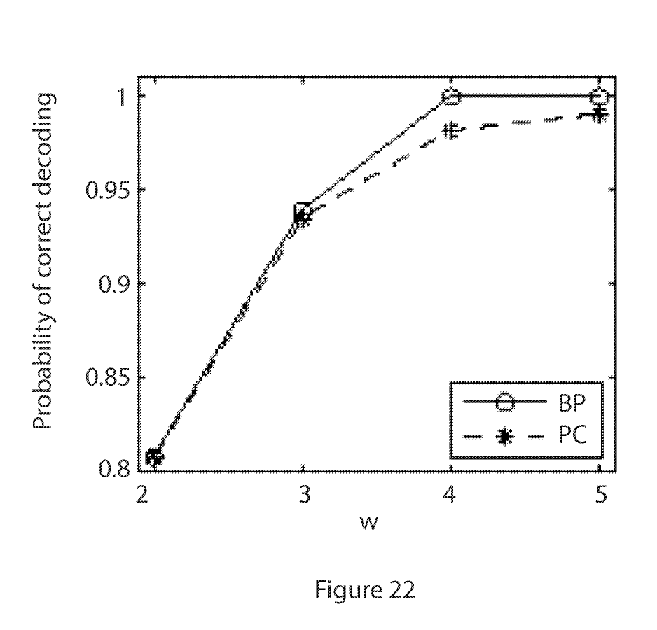

The performance of the algorithm continues to be evaluated in a biologically-oriented setting—detecting carriers for CF W1282X mutation, where the carrier rate in some populations is about 1.8%. The relatively high rate of the carriers challenges our scheme with a difficult genetic screening problem. Moreover, the sequence difference between the WT allele and the mutant allele is only a single base substitution, and sequencing error may cause genotype confounding. To reiterate, the inventors introduced increasing levels of symmetric confounding errors (i.e the two alleles have the same probability of being converted from one to the other), and tested the performance of the reconstruction algorithms with β=10³ and β=10⁴, and with error rates in the range of 0%-4.5% with steps of 0.5% (FIG. 21). As expected, the pattern consistency decoder performed poorly even for the lowest error rate of 0.5% and marked all specimens as carriers. The belief propagation algorithm reported the correct genotype for all specimens even when the error rate was 1.5% and β=10³. Importantly, the decoding mistakes of the belief propagation at higher error rates were false positives, and did not affect the sensitivity of the method. When the number of reads was increased for each query to β=10⁴, the belief propagation decoder reported the genotype of all the specimens without any mistake. As discussed above, the expected confounding error rate for this mutation up to 1%, implying that the parameters used in the simulation are quite conservative.

The inventors also tested another CF mutation, ΔF508, which has a similar carrier rate in people of European descent as W1282X, but contains a 3-nucleotide deletion when compared to the WT allele. This implies that the confounding error rates are negligible, as sequencing-induced deletions are quite rare. In this example, the inventors evaluated the effect of different weights for the query designs, and used the following sets of query windows: {33, 34}, {33, 34, 35}, {33, 34, 35, 37}, {33, 34, 35, 37, 41}. FIG. 21 depicts the results for the belief propagation algorithm and for the pattern consistency decoder. While the results are quite poor for w=2, the belief propagation decodes correctly all the specimens with w=4, which would requires the synthesis of only 37 barcodes, and a total of 139 queries.

Among various applications for the presently disclosed inventive methods, the inventors envision that the methods disclosed in the present invention can be applied to a wide variety of biological problems, including the determination of genotypic variation within large populations of individuals.

Other embodiments, extensions, and modifications of the ideas presented above are comprehended and within the reach of one skilled in the art upon reviewing the present disclosure. Accordingly, the scope of the present invention in its various aspects should not be limited by the examples and embodiments presented above. The individual aspects of the present invention, and the entirety of the invention should be regarded so as to allow for modifications and future developments within the scope of the present disclosure. The present invention is limited only by the claims that follow.

What is claimed is:

1. A method of associating a DNA sequence with a specimen pooled among a plurality of specimens, the method comprising:
A) selecting specimens from a total number of specimens for pools within a group,
the specimens selected for pools in a pattern according to a pooling window, the pooling window being an integer;
B) associating an identifier with each specimen within each pool,
where the identifier associated with each pool is unique to the pool;
C) aggregating each of the pools into a group;
D) repeating steps A) through C) to produce a plurality of groups,
each pooling window being different,
and the least common multiplier of any pair of pooling windows for each group being greater than the total number of samples;
E) sequencing each group using a DNA sequencing platform to produce a plurality of sequence reads,
each sequencing read including both a state and the unique identifier of each specimen; and
F) associating at least one of the states with each specimen using the identifier associated with each pool.

2. The method of claim 1, further comprising:
G) setting a threshold equivalent to the number of groups;
H) determining a number of specimens associated with the rare state greater than or equal to the threshold; and
I) assigning the rare state to each specimen associated with the rare state greater than the threshold.

3. The method of claim 1 wherein each state is associated with a specimen by eliminating assignments of the state inconsistent with the plurality of sequencing reads.

4. The method of claim 1 wherein each state associated with a specimen includes a grade.

5. The method of claim 4, wherein the grade is a specimen/state combination.

6. The method of claim 5, wherein the grade is provided by dividing a number of sequence reads of a state by the number of sequence reads of the pool containing the state.

7. The method of claim 6, further comprising:
G) determining a specimen with the highest grade; and
H) assigning a rare state to the specimen with the highest grade.

8. The method of claim 7, further comprising:
I) determining a specimen with the second highest grade; and
J) determining a quality of the assignment,
the quality determined by determining the difference between the specimen with the highest grade and the specimen with the second highest grade.

9. Computer software for analyzing information provided by a DNA sequencer and identifying a genotype of each of a plurality of specimens, the specimens being grouped into a plurality of pools, each of the pools containing a unique subset of the specimens, the DNA sequencer providing information indicative of the genotypes contained in each pool, the software comprising:
first and second routines,
the first and second routines iteratively exchanging first and second information,
the first information being sent from the first routine to the second routine,
the second information being sent from the second routine to the first routine,
the first information indicating that one or more specimens in a pool are restricted to a subset of possible genotypes,
the second information indicating that a particular specimen is restricted to a subset of possible genotypes,
the first routine using information from the DNA sequencer and the second information to associate a subset of specimens in a pool with a subset of possible genotypes,
the second routine using the first information to associate individual specimens with a particular genotype.

10. The software of claim 9, wherein the first and second routines comprise belief propagation algorithms.

11. The software of claim 9, wherein the first and second routines include Monte-Carlo simulations.

12. The software of claim 11, wherein oscillations in the Monte-Carlo simulations are attenuated with a damping algorithm.

13. The software of claim 9, wherein each pool contains a maximum of 1,000 specimens.

14. The software of claim 9, wherein the first and second routines comprise a greedy algorithm.

15. A method for analyzing information provided by a DNA sequencer and identifying a genotype of each of a plurality of specimens, the method comprising:
grouping the specimens into a plurality of pools, each of the pools containing a unique subset of the specimens,
determining information indicative of the genotypes contained in each pool,
identifying a genotype of each of the plurality of specimens according to the following algorithm:
analyzing the information by concurrently using first and second routines, wherein the analyzing comprises
iteratively exchanging first and second information,
the first information being sent from the first routine to the second routine,
the second information being sent from the second routine to the first routine,
the first information indicating that one or more specimens in a pool are restricted to a subset of possible genotypes,
the second information indicating that a particular specimen is restricted to a subset of possible genotypes,
the first routine using information from the DNA sequencer and the second information to associate a subset of specimens in a pool with a subset of possible genotypes,
the second routine using the first information to associate individual specimens with a particular genotype.

16. The method of claim 15, wherein the genotypes are determined using Monte-Carlo simulations.

17. The method of claim 16, wherein oscillations in the Monte-Carlo simulations are attenuated with a damping algorithm.

18. The method of claim 15, wherein the information for each pool comprises probability values that a specific genotype is contained with in the pool.

19. The method of claim 15, wherein the information is exchanged using a belief propagation algorithm.

20. The method of claim 15, wherein the genotypes are determined using a belief propagation algorithm.

21. The method of claim 15, wherein each pool contains a maximum of 1,000 specimens.

22. The method of claim 15, wherein the genotypes are determined using a greedy algorithm.

23. A method of determining an existence of a genotype in a pooled sample of specimens, the method comprising:
creating a plurality of pools of specimens;
determining information indicative of the genotypes contained in each pool, wherein the information for at least some of the pools indicates that the specimens in the at least some of the pools are restricted to a subset of possible genotypes; and
iteratively determining the genotypes present in each pool based on the information indicative of the genotypes contained in other pools.

24. The method of claim 23, wherein the genotypes are determined using Monte-Carlo simulations.

25. The method of claim 24, wherein oscillations in the Monte-Carlo simulations are attenuated with a damping algorithm.

26. The method of claim 23, wherein the information for each pool comprises probability values that a specific genotype is contained with in the pool.

27. The method of claim 23, wherein the information is exchanged using a belief propagation algorithm.

28. The method of claim 23, wherein the genotypes are determined using a belief propagation algorithm.

29. The method of claim 23, wherein each pool contains a maximum of 1,000 specimens.

30. The method of claim 23, wherein the genotypes are determined using a greedy algorithm.

31. A method of associating a DNA sequence with a causative genetic disease and a specimen pooled among a plurality of specimens, the method comprising:
A) selecting specimens from a total number of specimens for pools within a group,
the specimens selected for pools in a pattern according to a pooling window, the pooling window being an integer,
the specimens representing individuals affected by genetic disease;
B) associating an identifier with each specimen within each pool,
where the identifier associated with each pool is unique to the pool;
C) aggregating each of the pools into a group;
D) repeating steps A) through C) to produce a plurality of groups,
each pooling window being different,
and the least common multiplier of any pair of pooling windows for each group being greater than the total number of samples;
E) sequencing an exon region of each group using a DNA sequencing platform to produce a plurality of sequence reads,
each sequencing read including both a state and the unique identifier of each specimen; and
F) associating at least one of the states with each specimen using the identifier associated with each pool.

32. The method of claim 31, further comprising:
G) determining, for each sequence, whether the sequence is present in at least one reference sequence.

33. The method of claim 32, further comprising:
H) determining, for each sequence, if each sequence is not present in at least one reference sequence, whether a mutation in the sequence causes a change in an amino acid.

34. The method of claim 33, further comprising:
I) determining, for each sequence, if a mutation causes a change in an amino acid in the sequence, whether the sample is homozygous.


SEQUENCE LISTING (8 sequences)

SEQ ID NO: 1 - DNA, 27 bp, Homo sapiens
atcatctttggtgtttcctatgatgaa

SEQ ID NO: 2 - DNA, 27 bp, Homo sapiens
atcattggtgtttcctatgatgaatat

SEQ ID NO: 3 - DNA, 16 bp, Homo sapiens
tggaggaaagcctttg

SEQ ID NO: 4 - DNA, 16 bp, Homo sapiens
tgaaggaaagcctttg

SEQ ID NO: 5 - DNA, 96 bp, Artificial Sequence
  Description of Artificial Sequence Synthetic primer
caagcagaagacggcatacgagatcggtctcggcattcctgctgaaccgctcttccatctnnnnnnnngcgactcggtatttggatgaatgagtcg

SEQ ID NO: 6 - DNA, 59 bp, Artificial Sequence
  Description of Artificial Sequence Synthetic primer
aatgatacggcgaccaccgagatctacacctcggacgcatattacacatgttcatacac

SEQ ID NO: 7 - DNA, 25 bp, Artificial Sequence
  Description of Artificial Sequence Synthetic primer
atcgttgcctgcacatcttggaaac

SEQ ID NO: 8 - DNA, 65 bp, Artificial Sequence
  Description of Artificial Sequence Synthetic primer
cggtctcggcattcctgctgaaccgctcttccgatctnnnnnnnnnnacatctgtggcttcacta